(19) United States
(12) Patent Application Publication
(10) Pub. No.: US 2016/0294511 A1
(43) Pub. Date: Oct. 6, 2016

(54) REUSE OF A PARTIALLY RECEIVED INTERNET PROTOCOL PACKET IN EMBMS

(71) Applicant: QUALCOMM Incorporated, San Diego, CA (US)

(72) Inventors: Shailesh MAHESHWARI, San Diego, CA (US); Kuo-Chun LEE, San Diego, CA (US); Sivaramakrishna VEEREPALLI, San Diego, CA (US); Jack Shyh-Hurng SHAUH, San Diego, CA (US); Ralph Akram GHOLMIEH, San Diego, CA (US); Mohan Krishna GOWDA, San Diego, CA (US)

(21) Appl. No.: 14/818,111

(22) Filed: Aug. 4, 2015

Related U.S. Application Data
(60) Provisional application No. 62/140,272, filed on Mar. 30, 2015.

(51) Int. Cl. H04L 1/00; H04L 29/08; H04L 29/06; H04L 12/18

(52) U.S. Cl. CPC H04L 1/0045; H04L 12/189; H04L 67/06; H04L 69/22

(57) ABSTRACT

A method, an apparatus, and a computer program product for wireless communication are provided. The apparatus is for wireless communication with a serving cell. The apparatus receives a first segment of a first IP packet in a first MBSFN subframe. The IP packet can include a data related to an eMBMS service. The apparatus determines a second segment of the first IP packet is not received in a second MBSFN subframe. The apparatus assembles a replacement IP packet that includes the first segment of the first IP packet and a first IP header. The apparatus performs FEC on the replacement IP packet.

### CROSS-REFERENCE TO RELATED APPLICATION(S)

This application claims the benefit of U.S. Provisional Application Ser. No. 62/140,272, entitled “REUSE OF A PARTIALLY RECEIVED INTERNET PROTOCOL (IP) PACKET IN eMBMS” and filed on Mar. 30, 2015, which is expressly incorporated by reference herein in its entirety.

### BACKGROUND

1. Field

The present disclosure relates generally to communication systems, and more particularly, to communications systems, and more particularly, reuse of a partially received internet protocol (IP) packet in eMBMS.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, an apparatus, and a computer-readable are provided. The method is for wireless communication with a serving cell. The method includes receiving a first segment of a first internet protocol (IP) packet in a first multicast broadcast single frequency network (MBSFN) subframe. The IP packet can include a data related to an eMBMS service. The method further includes determining a second segment of the first IP packet is not received in a second MBSFN subframe. In addition, the method includes assembling a replacement IP packet that includes the first segment of the first IP packet and a first IP header. Furthermore, the method includes performing forward error correction (FEC) on the replacement IP packet.

The apparatus is for wireless communication with a serving cell. The apparatus receives a first segment of a first IP packet in a first MBSFN subframe. The IP packet can include a data related to an eMBMS service. The apparatus determines a second segment of the first IP packet is not received in a second MBSFN subframe. The apparatus assembles a replacement IP packet that includes the first segment of the first IP packet and a first IP header. The apparatus performs FEC on the replacement IP packet.

The computer-readable medium is for wireless communication with a serving cell. The computer-readable medium is configured for receiving a first segment of a first internet protocol (IP) packet in a first multicast broadcast single frequency network (MBSFN) subframe. The IP packet can include a data related to an eMBMS service. In addition, the computer-readable medium is configured for determining a second segment of the first IP packet is not received in a second MBSFN subframe. The computer-readable medium is further configured for assembling a replacement IP packet that includes the first segment of the first IP packet and a first IP header. Still further, the computer-readable medium is configured for performing forward error correction (FEC) on the replacement IP packet.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIGS. 7A and 7B are a diagram illustrating an example of an evolved Multimedia Broadcast Multicast Service channel configuration in a Multicast Broadcast Single Frequency Network.

FIG. 7C is a diagram illustrating a format of a Multicast Channel Scheduling Information Media Access Control element.

FIG. 8 is a diagram illustrating eMBMS protocol layers.

FIG. 9 is a first diagram for illustrating exemplary embodiments.

FIG. 10 is a second diagram for illustrating exemplary embodiments.

FIG. 11 is a third diagram for illustrating exemplary embodiments.

FIGS. 12A-12B are a fourth diagram for illustrating exemplary embodiments.

FIGS. 13A-13C are a fifth diagram for illustrating exemplary embodiments.

FIGS. 14A-14B are a sixth diagram for illustrating exemplary embodiments.

FIGS. 15A-15B are a flow chart of a method of wireless communication.

FIG. 16 is a conceptual data flow diagram illustrating the data flow between different modules/means/components in an exemplary system.

FIG. 17 is a diagram illustrating an example of a hardware implementation for an apparatus employing a processing system.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, the described concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

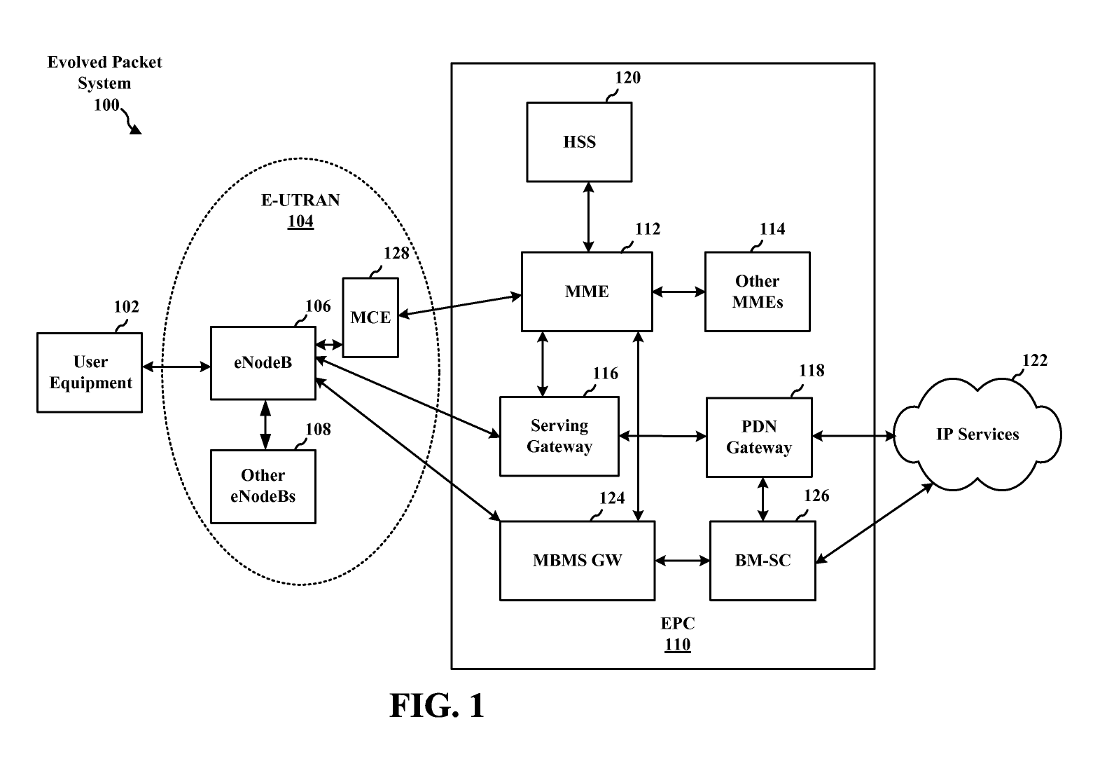

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

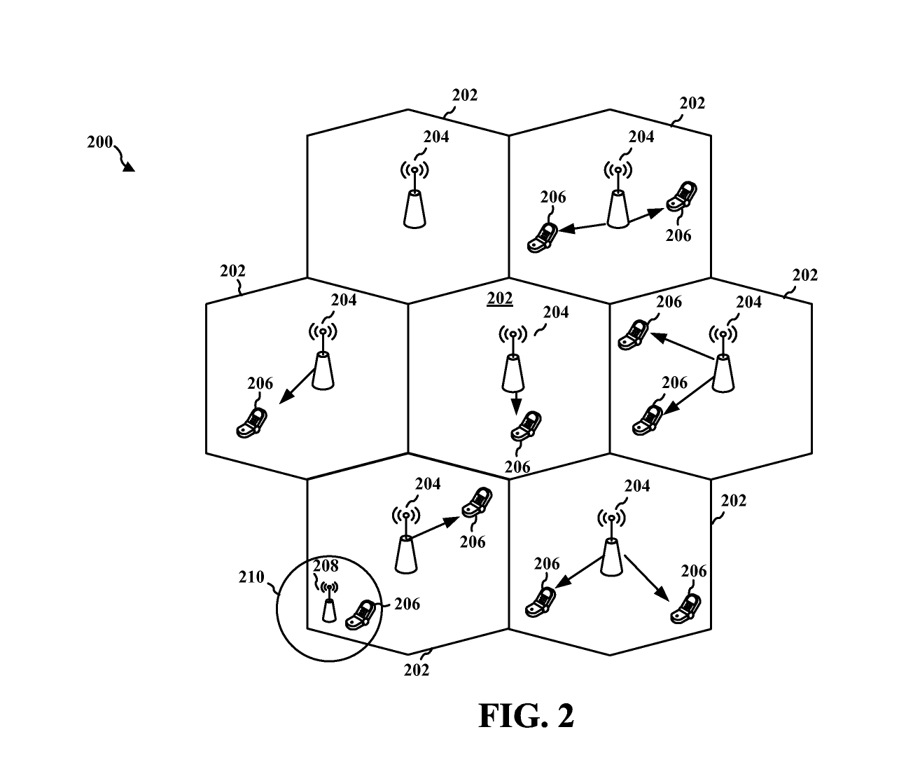

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

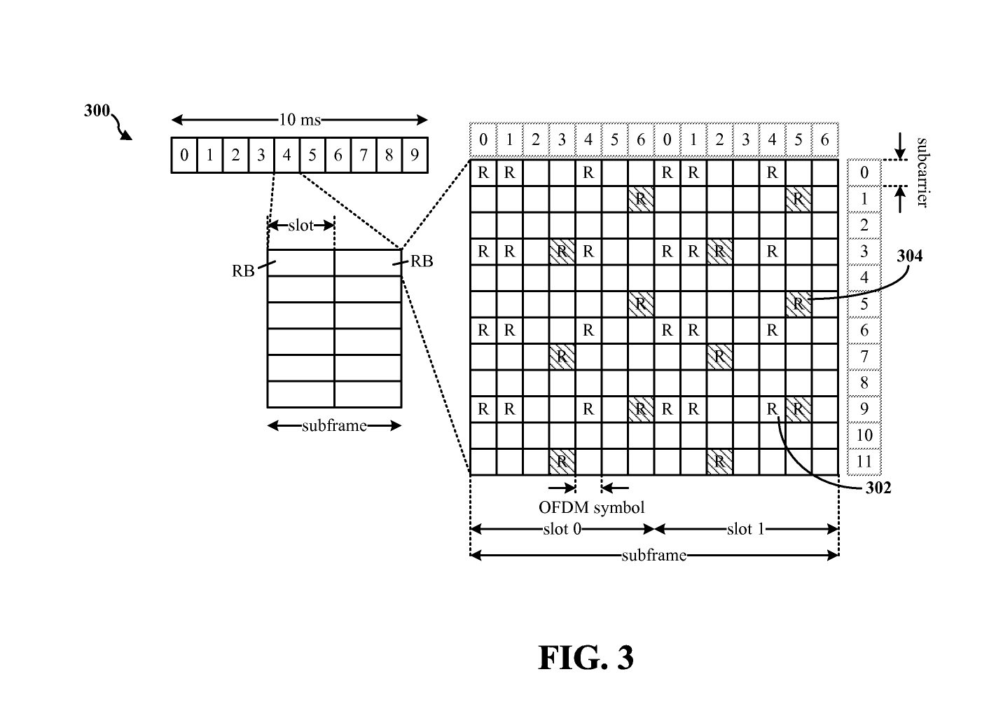

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

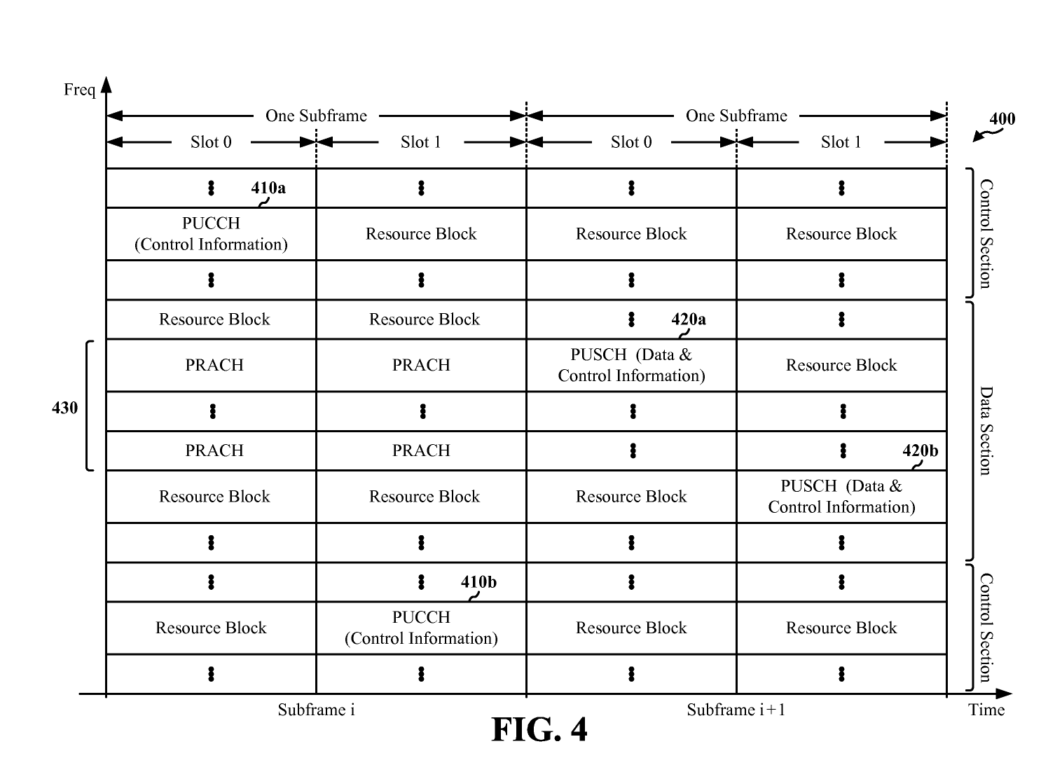

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

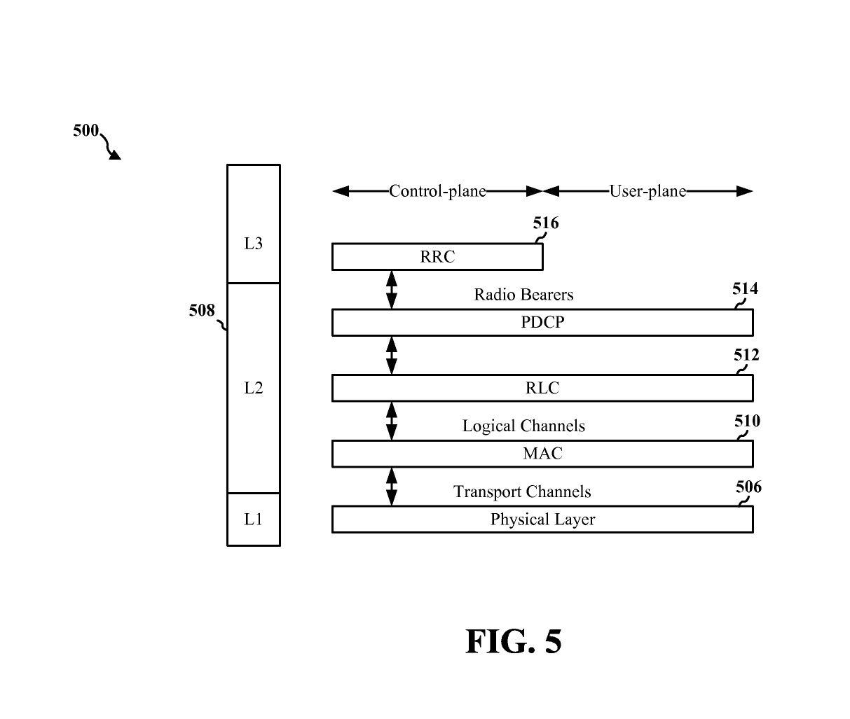

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1(L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

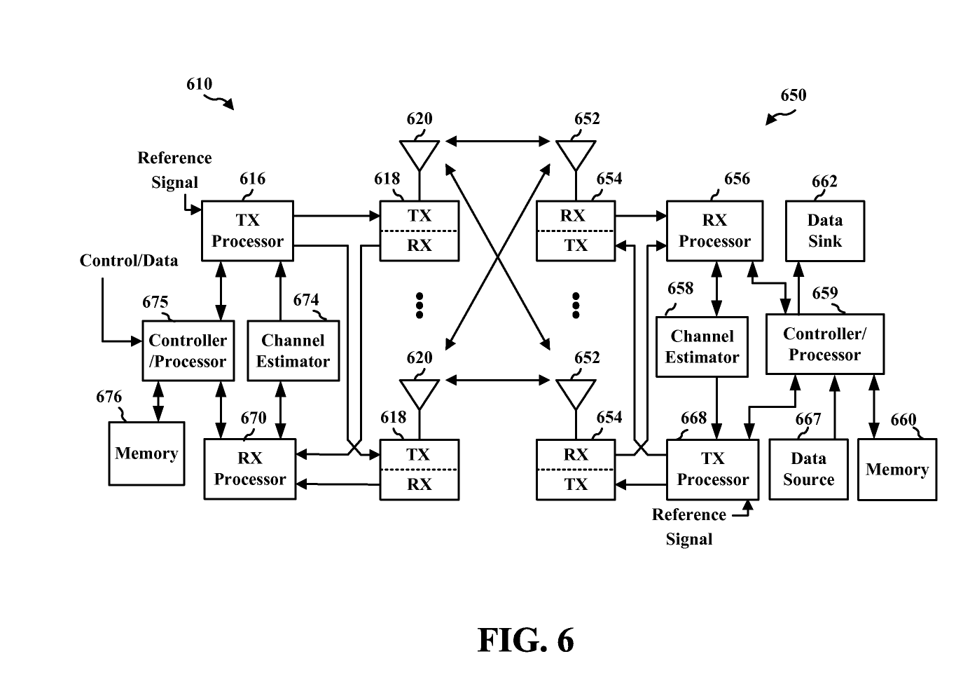

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

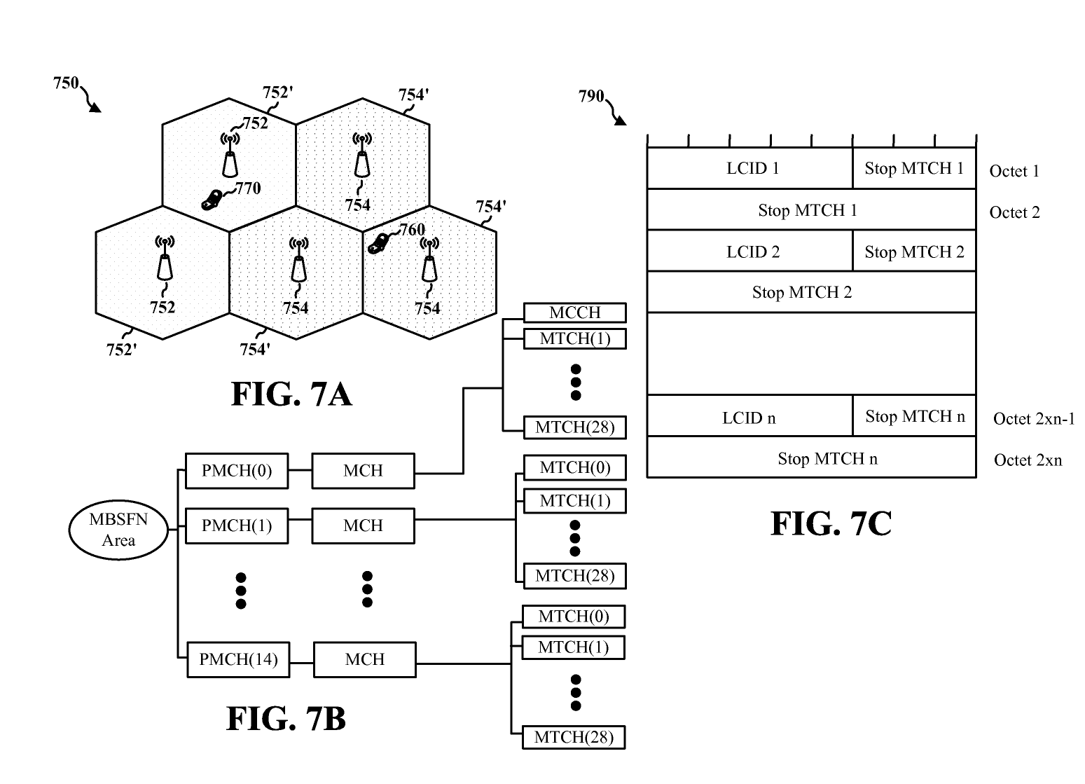

FIG. 7A is a diagram 750 illustrating an example of an evolved MBMS (eMBMS) channel configuration in an MBSFN. The eNBs 752 in cells 752′ may form a first MBSFN area and the eNBs 754 in cells 754′ may form a second MBSFN area. The eNBs 752, 754 may each be associated with other MBSFN areas, for example, up to a total of eight MBSFN areas. A cell within an MBSFN area may be designated a reserved cell. Reserved cells do not provide multicast/broadcast content, but are time-synchronized to the cells 752′, 754′ and may have restricted power on MBSFN resources in order to limit interference to the MBSFN areas. Each eNB in an MBSFN area synchronously transmits the same eMBMS control information and data. Each area may support broadcast, multicast, and unicast services. A unicast service is a service intended for a specific user, e.g., a voice call. A multicast service is a service that may be received by a group of users, e.g., a subscription video service. A broadcast service is a service that may be received by all users, e.g., a news broadcast. Referring to FIG. 7A, the first MBSFN area may support a first eMBMS broadcast service, such as by providing a particular news broadcast to UE 770. The second MBSFN area may support a second eMBMS broadcast service, such as by providing a different news broadcast to UE 760. Referring to FIG. 7B, each MBSFN area supports one or more physical multicast channels (PMCH) (e.g., 15 PMCHs). Each PMCH corresponds to a multicast channel (MCH). Each MCH can multiplex a plurality (e.g., 29) of multicast logical channels. Each MBSFN area may have one multicast control channel (MCCH). As such, one MCH may multiplex one MCCH and a plurality of multicast traffic channels (MTCHs) and the remaining MCHs may multiplex a plurality of MTCHs.

A UE can camp on an LTE cell to discover the availability of eMBMS service access and a corresponding access stratum configuration. Initially, the UE may acquire a system information block (SIB) 13 (SIB13). Subsequently, based on the SIB13, the UE may acquire an MBSFN Area Configuration message on an MCCH. Subsequently, based on the MBSFN Area Configuration message, the UE may acquire an MCH scheduling information (MSI) MAC control element. The SIB13 may include (1) an MBSFN area identifier of each MBSFN area supported by the cell; (2) information for acquiring the MCCH such as an MCCH repetition period (e.g., 32, 64, . . . , 256 frames), an MCCH offset (e.g., 0, 1, . . . , 10 frames), an MCCH modification period (e.g., 512, 1024 frames), a signaling modulation and coding scheme (MCS), subframe allocation information indicating which subframes of the radio frame as indicated by repetition period and offset can transmit MCCH; and (3) an MCCH change notification configuration. There is one MBSFN Area Configuration message for each MBSFN area. The MBSFN Area Configuration message may indicate (1) a temporary mobile group identity (TMGI) and an optional session identifier of each MTCH identified by a logical channel identifier within the PMCH, and (2) allocated resources (i.e., radio frames and subframes) for transmitting each PMCH of the MBSFN area and the allocation period (e.g., 4, 8, . . . , 256 frames) of the allocated resources for all the PMCHs in the area, and (3) an MCH scheduling period (MSP) (e.g., 8, 16, 32 , . . . , or 1024 radio frames) over which the MSI MAC control element is transmitted.

FIG. 7C is a diagram 790 illustrating the format of an MSI MAC control element. The MSI MAC control element may be sent once each MSP. The MSI MAC control element may be sent in the first subframe of each scheduling period of the PMCH. The MSI MAC control element can indicate the stop frame and subframe of each MTCH within the PMCH, and include a plurality of fields that each indicates the logical channel ID (LCID) of one of the MTCHs. There may be one MSI per PMCH per MBSFN area.

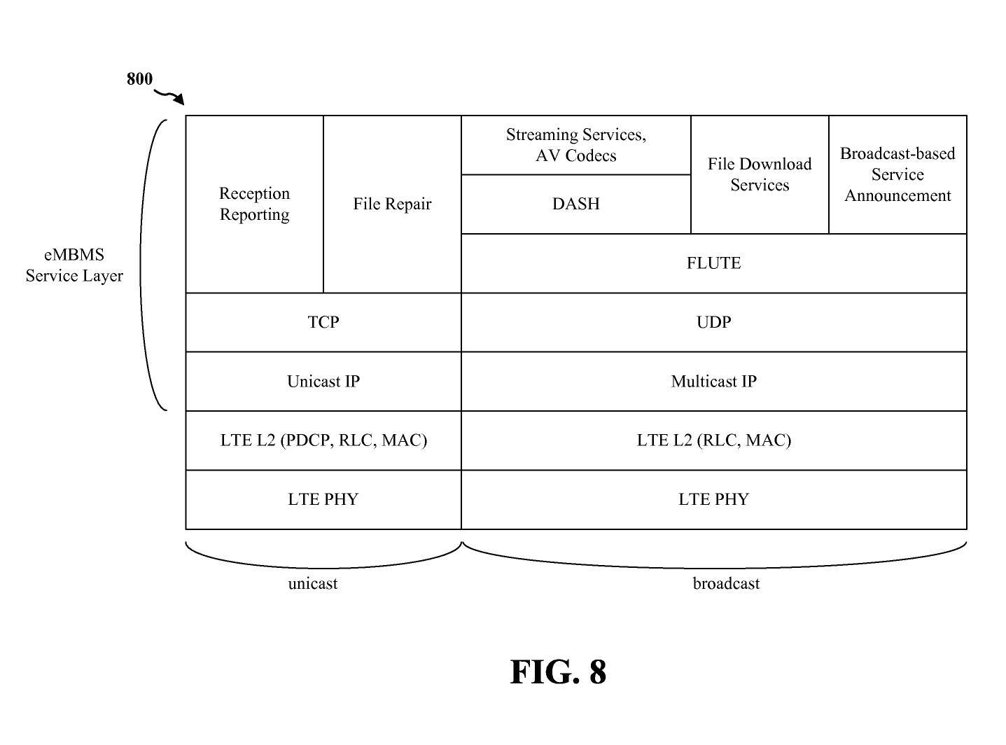

FIG. 8 is a diagram 800 illustrating eMBMS protocol layers. Unicast eMBMS supports reception reporting and file repair through transmission control protocol (TCP), unicast Internet Protocol (IP), LTE L2 (packet data convergence protocol (PDCP), radio link control (RLC), medium access control (MAC)), and LTE physical (PHY) protocol layers. Broadcast eMBMS supports streaming services, audio/video (AV) codecs, file download services, and broadcast-based service announcement through File Delivery over Unidirectional Transport (FLUTE), user datagram protocol (UDP), multicast IP, LTE L2 (RLC, MAC), and LTE PHY protocol layers. UEs can receive a user service description (USD) containing protocol information for receiving the eMBMS service. The protocol information may include a TMGI, which is a globally unique identifier for a particular MBMS service, an IP address/UDP port number, AV codec configuration, a FLUTE transport session identifier (TSI), a forward error correction (FEC) configuration, etc. The USD can be received through a procedure called service announcement. An eMBMS service layer includes the IP layers and the layers above the IP layers (TCP, UDP, FLUTE, etc.).

Forward error correction (FEC), e.g., a Raptor code, may be used to make reception of a MBMS service more robust. With a Raptor code, encoding symbols and/or FEC symbols can be generated from a given set of N source symbols (e.g., a video segment with N source symbols) such that the original N source symbols can be recovered from any subset of the received FEC symbols of size N+O, where O represents the number of additional FEC symbols due to FEC overhead needed to decode the N source symbols with a high probability of success, e.g., 99.9999%. When the number of errors are higher that the limit of FEC redundancy, the source symbols cannot be recovered by a higher layer protocol such as FLUTE and the data segment is dropped. This may result in a segment of video being dropped. In one aspect, video and audio data related to an eMBMS service can be transported by a sequence of dynamic adaptive streaming over HTTP (DASH) segments, where each segment may carry a few seconds of content duration. A DASH segment can be protected by FLUTE layer FEC. However, if errors in the DASH segment are higher than the limit of FEC redundancy, the FLUTE layer may not be able to recover the DASH segment.

Receiving a packet, e.g., an Internet Protocol (IP) packet, across more than one MBSFN subframe, can result in the RLC layer discarding the partially received IP packet even though there may be some recoverable FEC symbols in a partially received IP packet. Recovering the FEC symbols in the partially received IP packet rather than discarding such symbols may allow the source data to be recovered under higher error rates and/or may allow a network operator to reduce the overhead associated with the FEC for a given probability of decoding success, e.g., when FEC symbols are discarded in a partially received IP packet, additional FEC symbols may have to be received to compensate for the dropped symbols for a constant block error rate (BLER). Such a reduction in overhead can reduce transmission bandwidth required for MBMS transmission and increase system capacity.

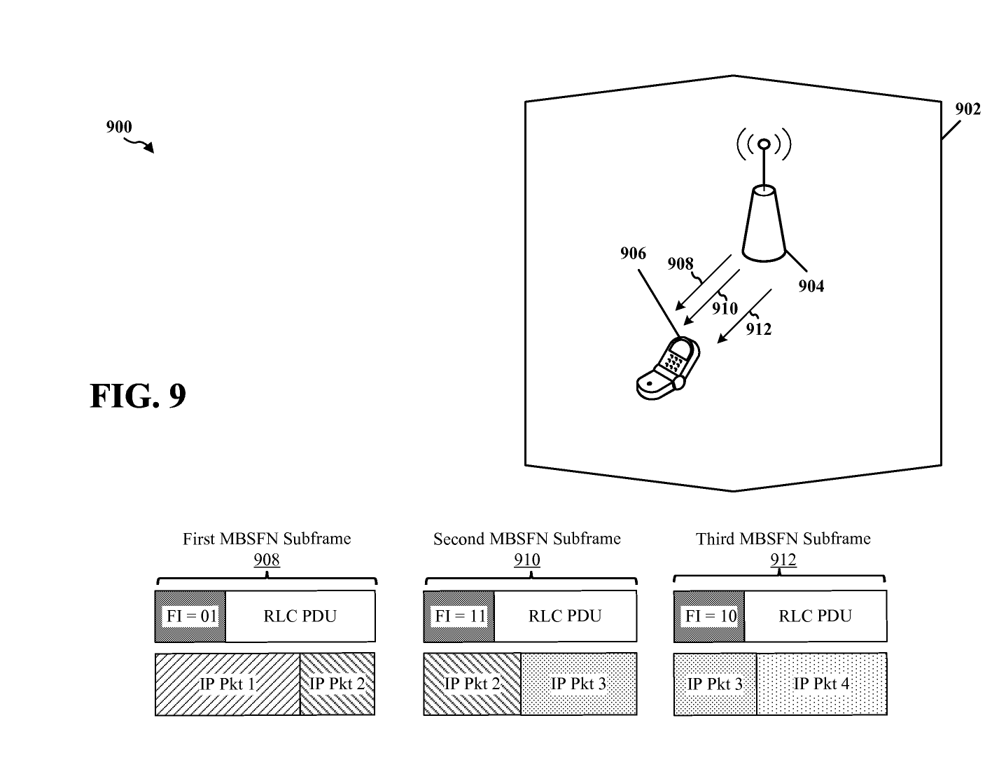

FIG. 9 is a diagram 900 for illustrating exemplary embodiments. For example, an eNB 904 located in an MBSFN cell 902 may send an eMBMS service to a UE 906 in one or more MBSFN subframes 908, 910, 912. For example, each MBSFN subframe 908, 910, 912 can carry one or more RLC protocol data units (PDU), and each RLC PDU can contain one or more IP packets. Each IP packet may carry one or more segments of video and/or audio data related to the eMBMS service. In one aspect, one IP packet can be segmented into one or more RLC PDUs. For example, a first MBSFN subframe 908 transmitted to the UE 906 can contain a single RLC PDU that carries an entire IP packet 1 and a first segment of IP packet 2. A second MBSFN subframe 910 transmitted to the UE 906 can contain a single RLC PDU that carries a second segment of IP packet 2 and a first segment of IP packet 3. A third MBSFN subframe 912 transmitted to the UE 906 can contain a single RLC PDU that carries the second segment of IP packet 3 and entire IP packet 4. The UE 904 can assemble the IP packets to provide the eMBMS service to a user. Although three MBSFN subframes are illustrated as being transmitted to the UE 906, one of ordinary skill in the art would understand that a greater or fewer number of the MBSFN subframes can be transmitted to the UE 906 as part of the eMBMS service.

In one aspect, each RLC PDU can include a two bit framing information (FI) field located in an RLC header of the RLC PDU. According to an exemplary embodiment, each of the two bits can correspond to a value of 0 or 1. For example, the first bit of the two bits in the FI field can provide information, to the UE 904, related to the IP packet or the segment of the IP packet occupying the beginning position of the respective RLC PDU. The second bit of the two bits in the FI field can provide information, to the UE 904, related to the IP packet or the segment of the IP packet occupying the ending position of the respective RLC PDU. In one aspect, a first bit of the two bits in the FI field can include a value of 0 or 1, which can indicate that a first byte of a data field of the RLC PDU corresponds or does not correspond, respectively, to a first byte of an RLC service data unit (SDU) or IP packet. The second bit of the two bits in the FI field can include a 0 or 1, which can indicate that the last byte of the data field of the RLC PDU corresponds or does not correspond, respectively, to the last byte of an RLC SDU or IP packet.

Referring again to FIG. 9, the first MBSFN subframe 908 includes, for example, an FI=01 in the header of the RLC PDU, which indicates to the UE 906 that the first MBSFN subframe 908 contains the entire IP packet 1 (e.g., the first byte of the data field) and the beginning segment of IP packet 2 (e.g., the second byte of the data field). The second MBSFN subframe 910 includes, for example, an FI=11 in the header of the RLC PDU, which indicates to the UE 906 that the second MBSFN subframe 910 contains the end segment of IP packet 2 (e.g., the first byte of the data field) and the beginning segment of IP packet 3 (e.g., the second byte of the data field). The third MBSFN subframe 912 includes, for example, an FI=10 in the header of the RLC PDU, which indicates to the UE 906 that the third MBSFN subframe 912 contains the end segment of IP packet 3 (e.g., the first byte of the data field) and entire IP packet 4 (e.g., the second byte of the data field). The RLC sequence number (SN) may also be needed to detect/determine which segment of the IP packet (e.g., first segment, middle segment, or end segment) has been lost.

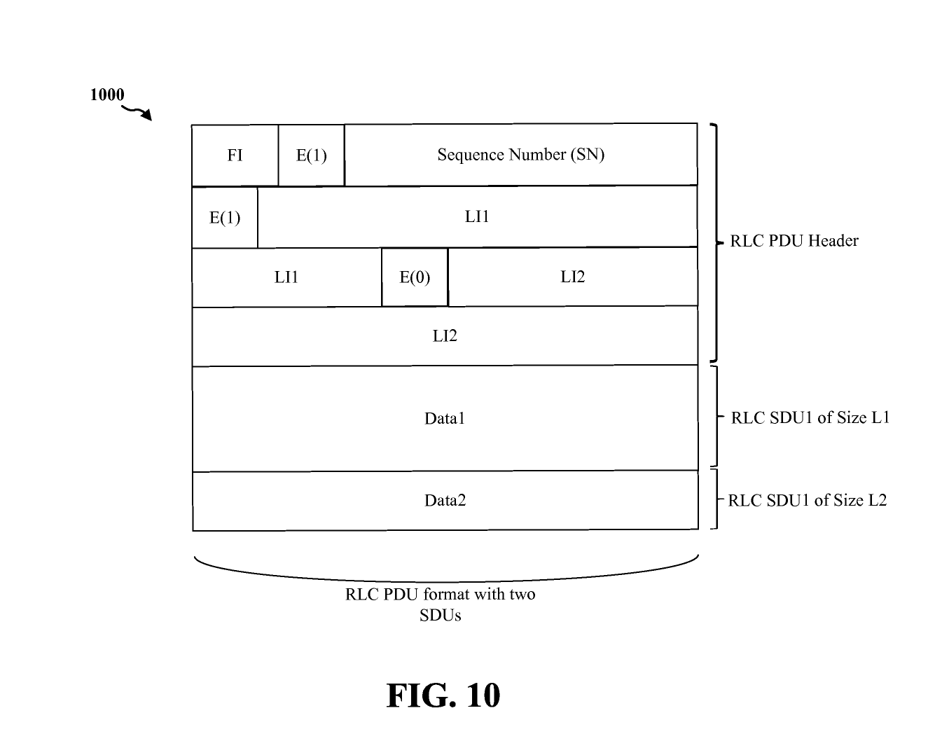

A more detailed diagram of an RLC PDU formatted with two SDUs can be seen in FIG. 10. For example, referring to FIG. 10, the RLC PDU can include an RLC PDU header and two RLC SDUs carrying one or more IP packets. The RLC PDU header can contain information that can be use by the UE 906 in reassembling the SDUs or IP packets. In one aspect, the RLC PDU header can include an FI field that indicates whether an RLC SDU or IP packet can be segmented at the beginning and/or end of the data field. The extension bit (E) field can indicate whether a data field follows or whether another E field and length indicator (LI) field follows the extension bit (E). For example, an E field of 0 indicates that a data field follows, and an E field of 1 indicates that another E field and LI field follows. The LI field can indicate the length, in bytes, of the corresponding data field element in the PDU. Referring to FIG. 10, Data1 can be the data field corresponding to RLC SDU1 and has a size of LI1, and Data2 can be the data field corresponding to RLC SDU2 and has a size of LI2. For example, with reference to the first MBSFN subframe 908 in FIG. 9, D1 could correspond to IP packet 1 and D2 would correspond to the first segment of IP packet 2.

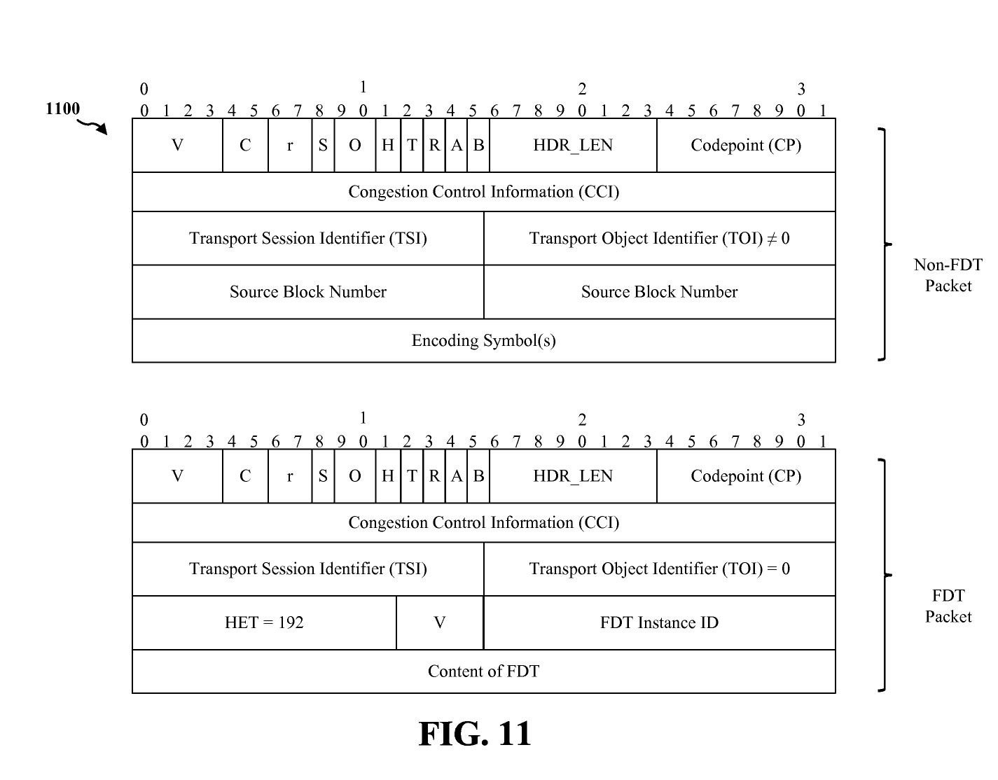

FIG. 11 is a diagram 1100 illustrating a FLUTE asynchronous layered coding (ALC)/layered coding transport (LCT) packet. In one aspect, the FLUTE ALC/LCT packet can include a file delivery table (FDT) packet and a non-FDT packet. For example, the non-FDT packet can carry a segment of video and/or audio, and can include a 16 byte FLUTE packet header followed by a sequence of FEC symbols, where the first symbol in the packet has an encoding symbol ID as part of the header. Each symbol in the non-FDT packet can have the same or different number of bytes. The FDT packet can carry control information related to the segment video and/or audio carried by the non-FDT packets which may repeat a few times in the duration of the segment. The header fields of the non-FDT packet and FDT packet can include one or more of the following:

V: Version Number

C: Congestion Control flag (e.g., C may be a two bit quantity and the flag is usually 1 bit)

r: Reserved

S: Transport Session Identifier flag

O: Transport Object Identifier flag (e.g., O can be a two bit quantity)

H: Half-word flag

T: Sender Current Time present flag

R: Expected Residual Time present flag

A: Close Session flag

B: Close Object flag

HDR₁₃ LEN: LCT Header Length

HET: Header Extension Type

CCI: Congestion Control Information

TOI: Transport Object Identifier

TSI: Transport Session Identifier

CP: Code Point

FDT Instance ID: File Delivery Table Instance ID

Encoding Symbols

Source Block Number

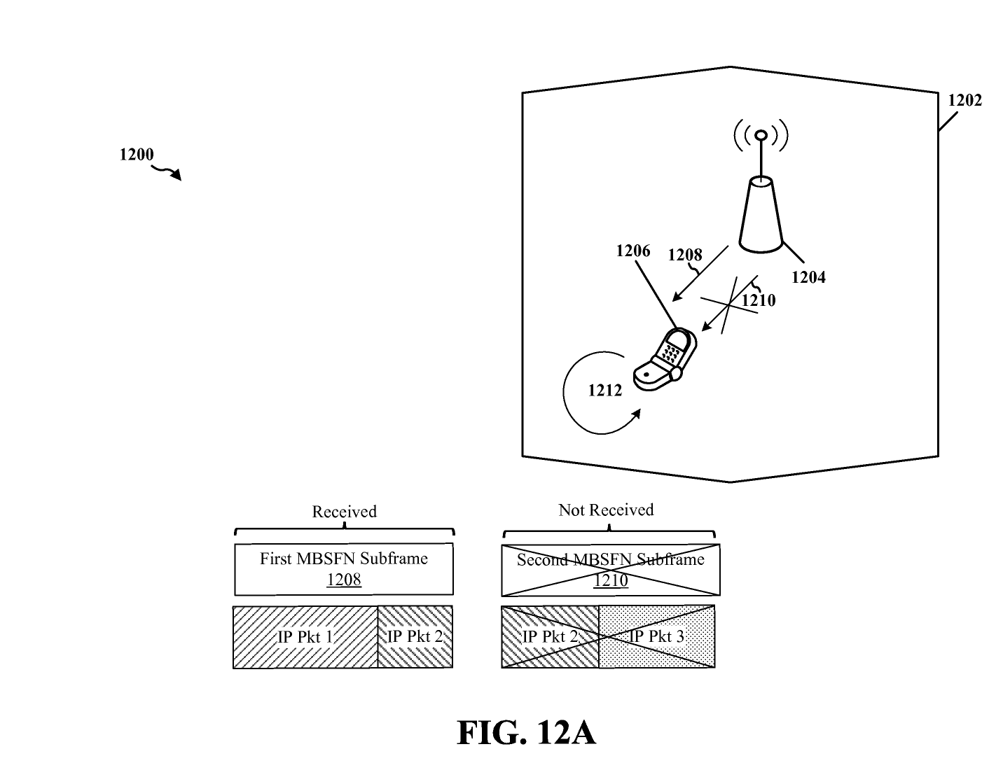

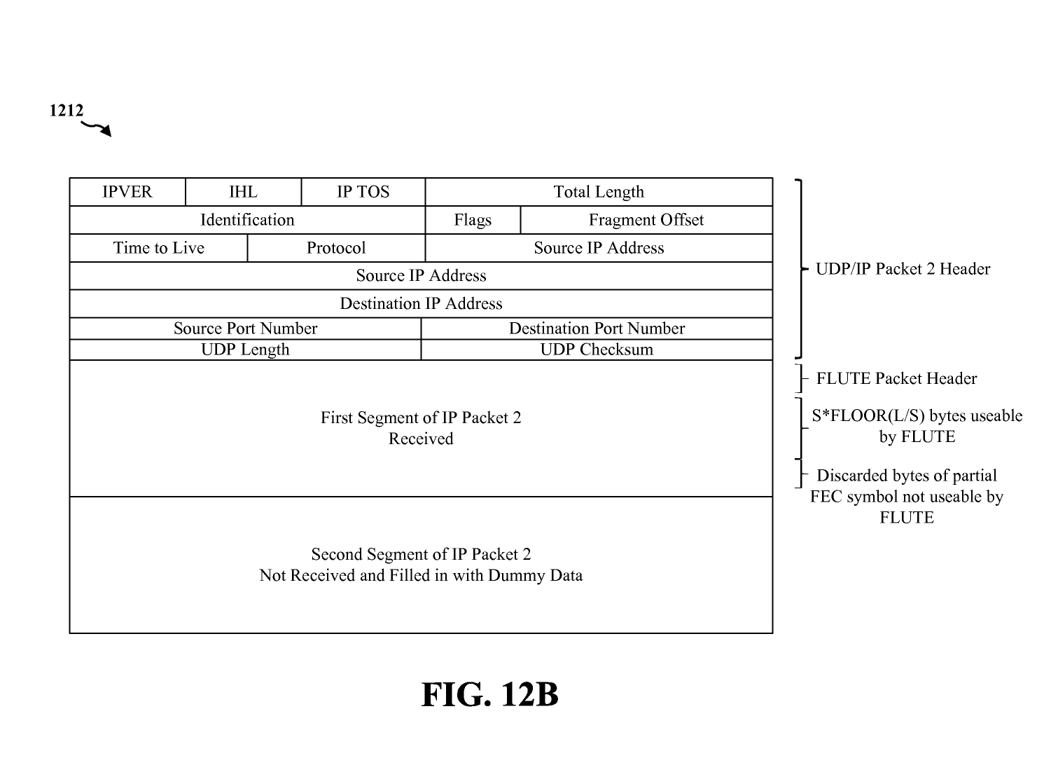

FIG. 12A is a diagram 1200 for illustrating exemplary embodiments. For example, an eNB 1204 located in an MBSFN cell 1202 may send an eMBMS service to a UE 1206 in one or more MBSFN subframes 1208, 1210. For example, each MBSFN subframe 1208, 1210 can carry one or more RLC PDUs (not illustrated in FIG. 12A), and each RLC PDU can carry one or more IP packets. Each IP packet can carry one or more segments of video and/or audio data related to the eMBMS service. In one aspect, one IP packet can be segmented across more than one MBSFN subframe. For example, a first MBSFN subframe 1208 transmitted to and received by the UE 1206 can contain entire IP packet 1 and a first segment of IP packet 2. However, a second MBSFN subframe 1210 containing the second segment of IP packet 2 and IP packet 3 may not be received by the UE 1206. For example, each IP packet may contain portions of video and audio data related to an eMBMS service. In one aspect, video and audio data related to an eMBMS service can be transported by a sequence of dynamic adaptive streaming over HTTP (DASH) segments, where each segment may carry a few seconds of content duration. A DASH segment can be protected by FLUTE layer FEC. However, if errors in the DASH segment are higher than the limit of FEC redundancy, the FLUTE layer may not be able to recover the DASH segment. As in the example of IP packet 2 in FIG. 12A, when the second segment of IP packet 2 is lost the UE 1206 can reassemble IP packet 2 1212 using the segment of IP packet 2 received in the first MBSFN subframe 1208 so that the FEC symbols received in the partially received segment of IP packet 2 are passed up to the higher layers rather than being discarded. In an aspect, the RLC layer can discard partially received FEC symbols prior to reassembling the IP packet or can insert the partially received IP packet with dummy data and let the upper layers discard partially received FEC symbols during the decoding process.

In an aspect, the RLC sequence number (SN) can be used to determine which segment of the IP packet has been lost. For example, in FIG. 12A, there may be two MBSFN subframes corresponding to the RLC Packets with SN=n, n+1, assuming one RLC PDU per MBSFN subframe. However, in this example, the UE receives only SN=n and does not receive SN=n+1 (and UE can receive another SN=n+2). Because SN=n+1 was not received, the UE knows that there is missing data and can apply the partially received IP packet procedure. In receiving SN=n, FI=01, the UE can determine that the initial part of the second IP packet has been received, and if SN=n+1 is not received, the UE can determine that the ending or middle part of the second IP packet has not been received. To confirm that SN=n+1 is the end segment of the IP packet and not the middle part, the UE can use Total length of the IP packet to make this determination. For example, assume that in SN=n, 100 bytes has been received by the UE for the second IP packet, and that IP header has Total length=1400 bytes. Therefore, if SN=n+1 is supposed to send 1500 bytes (e.g., which may be determined from the MCS of the second MBSFN subframe and/or the MBSFN transmission if the MCS is the same in each subframe), then the UE can detect that SN=n+1 is the end segment and not the middle part. On the other hand, if SN=n+1 is supposed to send 1200 bytes (e.g., which may be determined from the MCS of the second MBSFN subframe and/or the MBSFN transmission if the MCS is the same in each subframe), then the UE can detect that SN=n+1 is the middle part. Alternatively, IP packet size is typically constant and the UE can detect this constant value by receiving a few IP packets. As such, the RLC layer can predict which part is missing without needing the Total length when leading portion of the IP packet is missing.

With reference to FIG. 12B, a replacement IP packet 2 1212 when the second MBSFN subframe 1210 is not received by the UE 1206 is illustrated. Replacement IP packet 2 1212 can include a UDP/IP Packet 2 Header obtained from the first segment of IP packet 2 received in the first MBSFN subframe 1208, the first segment of IP packet 2 received in the first MBSFN subframe 1208, and dummy data filled in place of the second segment of IP packet 2. For example, the UDP/IP Packet 2 Header can include the following:

IP Version Number (IPVER): The version number can indicate the version of IP in use for the packet.

Header Length (IHL): The header length can indicate the overall length of the header. The UE 1206 can use the header length to determine when to stop reading the header and start reading data.

IP Type of Service (IP TOP): The Type of Service field can indicate the importance of the packet via a numerical value. Handling of a packet may be prioritized based on numerical value.

Total Length: Total length can indicate the total length of the IP packet in bytes.

Identification: If there is more than one IP packet, the identification field has an identifier that identifies the position of the IP packet. Segments of an IP packet can retain that IP packet's original ID number.

Flags: A first flag, if set, can be ignored. If a DF (Do Not Fragment) flag is set, then the packet will not be fragmented. The MF (More Fragments) bit can be turned on (1) to indicate there are more segments of an IP packet to come. The last segment of the IP packet will have the MF bit set to off (0).

Fragment Offset: If the Fragment Offest Flag field returns a 1 (on), the Offset field can contain the location of the missing piece(s) indicated by a numerical offset based on the total length of the packet.

Time to Live: The Time to Live can indicate the length of time that a packet may be allowed to remain in transit. If a packet is discarded or lost in transit, an indicator can be sent back to the eNB 1204 that the loss occurred. The eNB 1204 then has the option of resending that packet.

Protocol: The protocol field can hold a numerical value indicating the handling protocol in use for the packet.

Source IP Address: The source IP address field can indicate the IP address of the eNB 1204 sending the IP packet.

Destination IP Address: The destination IP address field can indicate the multicast destination (e.g., the UE 1206) IP address of the eMBMS service.

Source Port Number: The source port number field can indicate the source port number of the eNB and/or UE.

Destination Port Number: The destination port number field can indicate the destination port number of the UE and/or eNB.

UDP Length: The UDP length field can indicate the total length of UDP header and UDP data.

UDP Checksum: The UDP Checksum value acts as a validation checksum for the UPD Packet 2 Header and Data.

In an exemplary embodiment, when the UE 1206 determines that the first segment of IP packet 2 has been received but that the second segment of IP packet 2 has not been received, the UE (e.g., RLC layer) can reassemble IP packet 2 by filling out the missing second segment of IP packet 2 with dummy bytes of data. The RLC layer can then forward the replacement IP packet 2 to the FLUTE layer to allow recovery of FEC symbols contained in the replacement IP packet 2. In an exemplary embodiment, the RLC layer can indicate to the FLUTE layer which segment of replacement IP packet 2 1212 was received (e.g., the first segment of IP packet 2) and which part has dummy data (e.g., the second segment of IP packet 2). The FLUTE layer can discard the dummy data inserted in place of the second segment of IP packet 2. Referring to FIG. 12B, multiple FEC symbols may be included in the first segment of IP packet 2 following the UDP/IP Packet 2 header, each of S bytes, excluding the FLUTE packet header which follows the UDP/IP Packet 2 header. In one aspect, the FLUTE layer can use S*FLOOR(L/S) bytes of data to process and discard the remaining bytes of partial FEC symbols not useable by the FLUTE layer, where L can be the length of the successfully received data in the first segment of IP packet 2, excluding the FLUTE packet header which, for example, may include 16 bytes. FLOOR can be a function to take the lower integer of the non-integer number of bytes of data. For example, FLOOR(1350/100)=FLOOR(13.5)=13.

Therefore, in the case that an IP packet can be transmitted across more than one MBSFN subframe, and the UE 1206 does not receive one of the MBSFN subframes, e.g., due to an air interface transmission error or if the UE 1206 is a dual subscriber identity modules (SIMs) device that may periodically tune away to another radio access technology during MBMS reception, the present disclosure provides a mechanism by which the RLC layer can reassemble a partially received IP packet rather than drop the partially received IP packet (e.g., IP packet 2) allowing higher layers to recover additional FEC symbols present in the partially received IP packet. Thus, the present disclosure may provide better video streaming and/or file eMBMS file download services to the user.

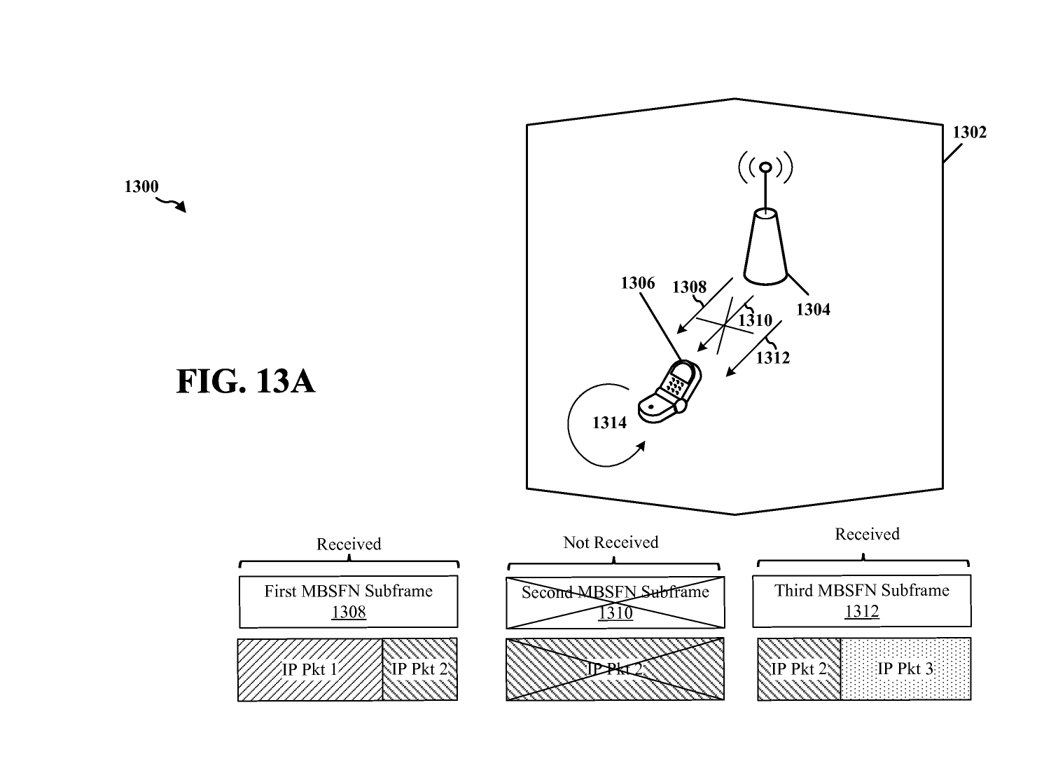

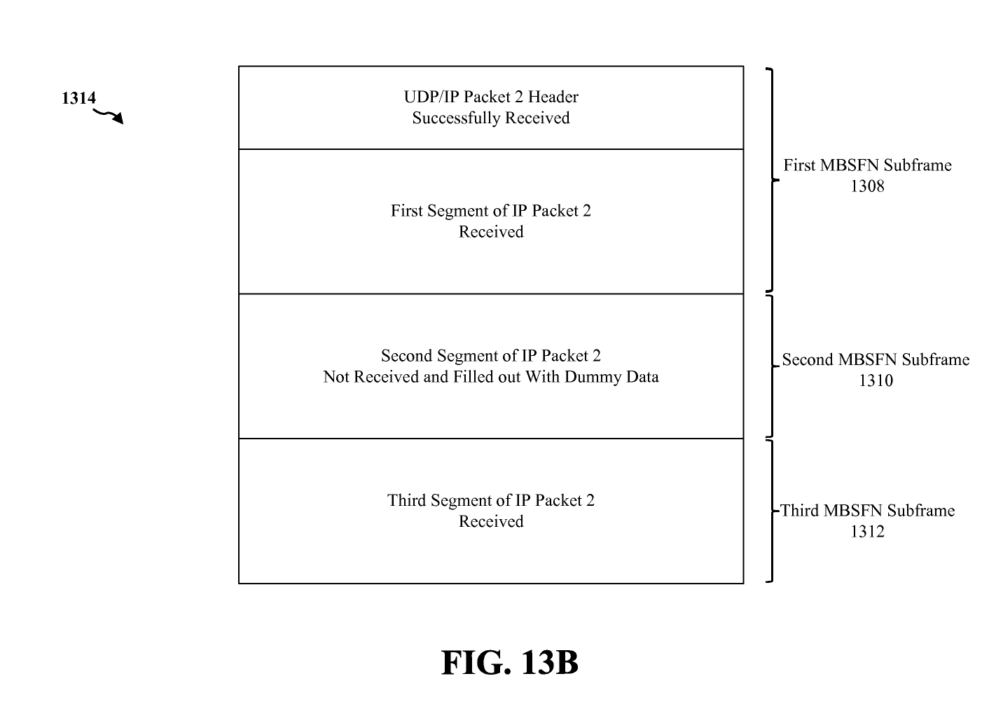

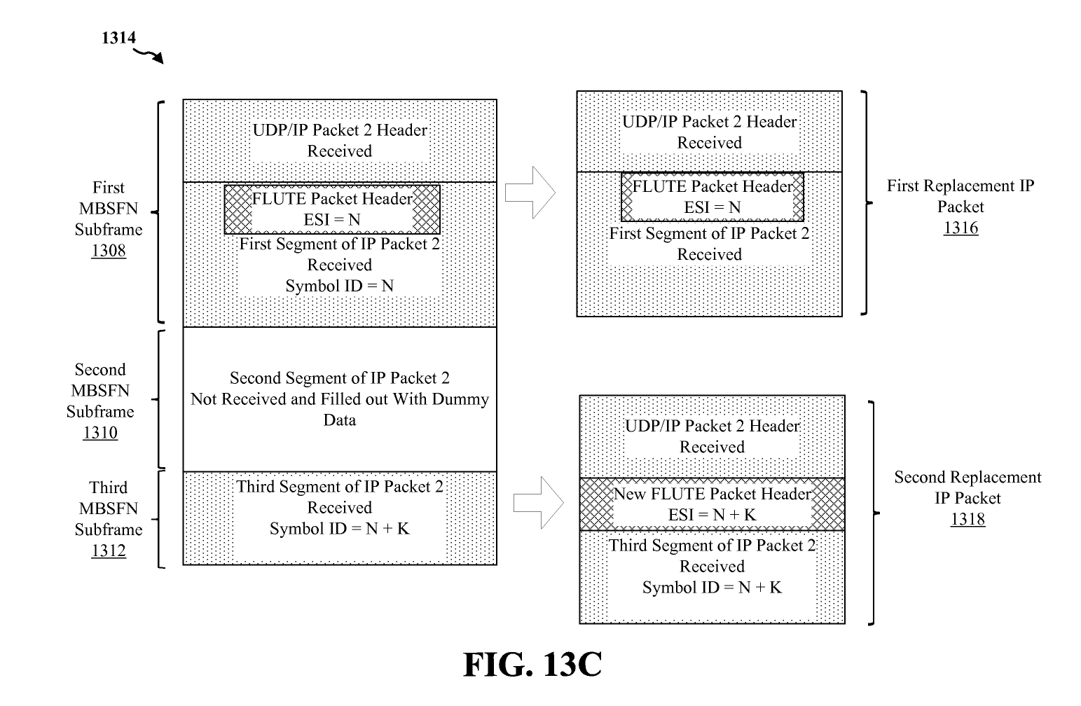

FIG. 13A is a diagram 1300 for illustrating exemplary embodiments. For example, an eNB 1304 located in an MBSFN cell 1302 may send an eMBMS service to a UE 1306 in one or more MBSFN subframes 1308, 1310, 1312. For example, each MBSFN subframe 1308, 1310, 1312 can carry one or more RLC PDU (not illustrated in FIG. 13A), and each RLC PDU can carry one or more IP packets. Each of the IP packets may carry one or more segments of video and/or audio data related to the eMBMS service. In one aspect, one IP packet can be segmented into more than one MBSFN subframe. For example, a first MBSFN subframe 1308 transmitted to and received by the UE 1306 can contain entire IP packet 1 and a first segment of IP packet 2. However, a second MBSFN subframe 1310 containing the second segment of IP packet 2 may not be received by the UE 1306. A third MBSFN subframe 1312 containing a third segment of the IP packet 2 and entire IP packet 3. In an exemplary embodiment, when the second segment of IP packet 2 is lost the UE 1306 can reassemble IP packet 2 1314 using the first segment of IP packet 2 received in the first MBSFN subframe 1308 and the third segment of IP packet 2 received in the third MBSFN subframe 1312.

In an exemplary embodiment, with reference to FIG. 13B, a replacement IP packet 2 1314 assembled when the second MBSFN subframe 1310 is not received by the UE 1306 is illustrated. Replacement IP packet 2 1314 can include a UDP/IP Packet 2 Header from the first segment of IP packet 2 received in the first MBSFN subframe 1308, the first segment of IP packet 2 received in the first MBSFN subframe 1308, dummy data filled in place of the missing second segment of IP packet 2, and the third segment of IP packet 2 received in the third MBSFN subframe. To determine the amount of dummy data to insert in the missing section segment of IP packet 2, the UE 1306 can refer to the Total Length field in the UDP/IP Packet 2 Header to determine the size of entire IP packet 2 and the RLC SDU size of the each data segment in the first and third segments of IP packet 2 received. The difference between the total size of the entire IP packet 2 and each of the received segments of IP packet 2 can be the amount of dummy data inserted into the replacement IP packet 2 1314.

In an exemplary embodiment, with reference to FIG. 13C, any partially received FEC symbols included in the first or third segments of IP packet 2 can be discarded, and the remainder of partially received IP packet 2 1314 can be separated into a first replacement IP packet 1316 and second replacement IP packet 1318. For example, the UE 1306 (e.g., the RLC layer) can assemble the first replacement IP packet 1316 to include the UDP/IP Packet 2 Header and the first segment of IP packet 2 received in the first MBSFN subframe 1308. In one aspect, the UE 1306 can generate a new FLUTE packet header based on the symbol ID included in the third segment of IP packet 2 and assemble the UDP/IP Packet 2 Header received in the first MBSFN subframe 1308 with the third segment of IP packet 2.

Therefore, in the case that an IP packet is transmitted across more than one MBSFN subframe and the UE 1306 does not receive one of the MBSFN subframes, e.g., due to an air interface transmission error or when the UE 1306 tunes away to another radio access technology from LTE, the present disclosure provides a mechanism by which the RLC layer can reassemble a partially received IP packet rather than drop the partially received IP packet (e.g., IP packet 2). Thus, the present disclosure can provide better video streaming and/or file download eMBMS services to the user.

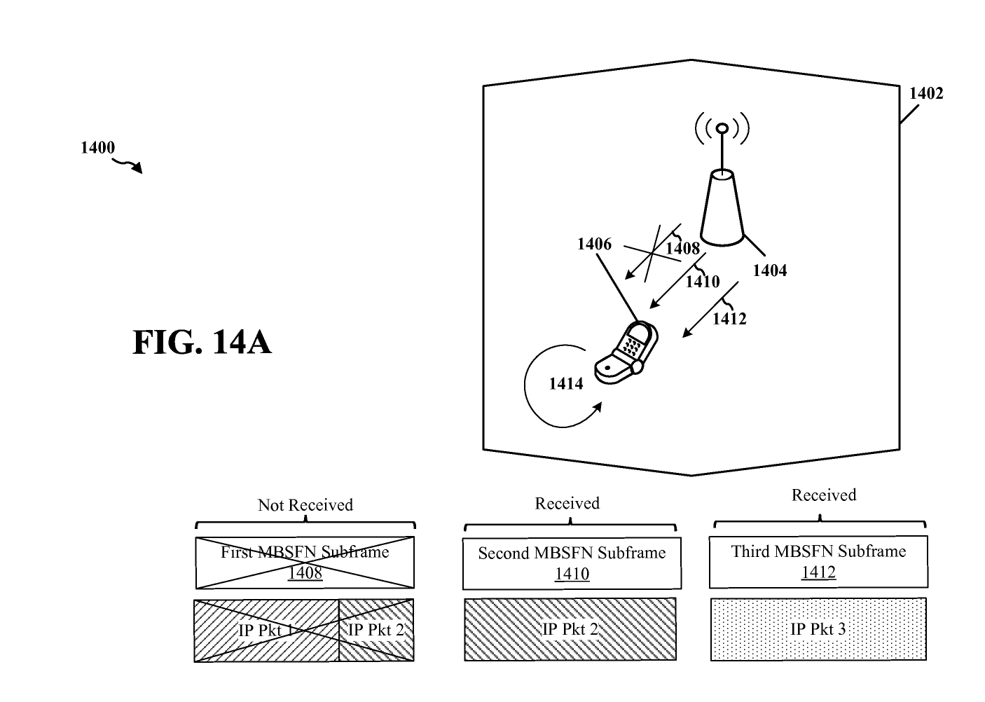

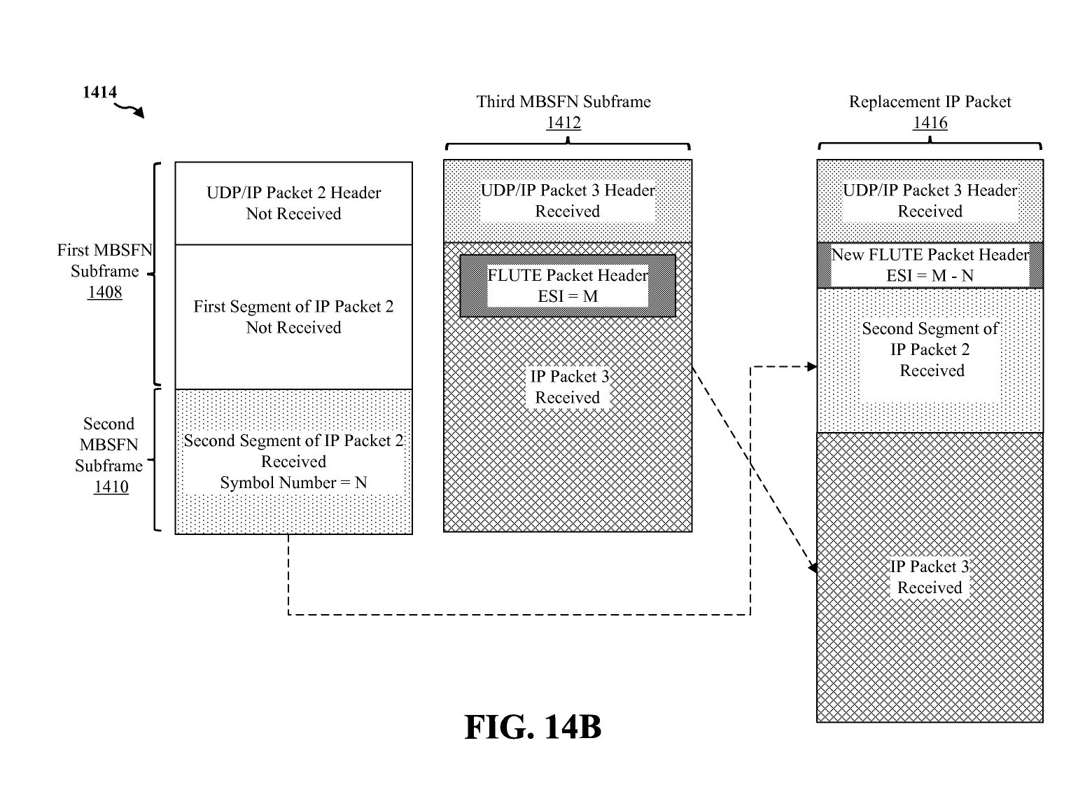

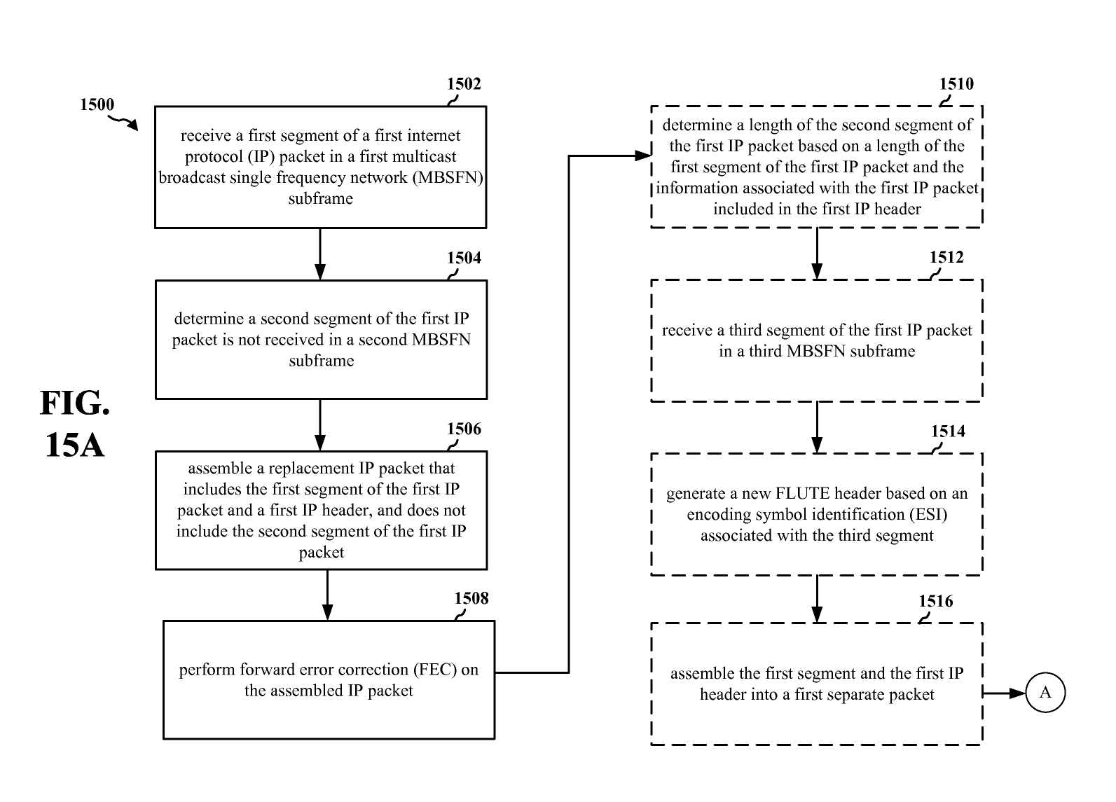

FIG. 14A is a diagram 1400 for illustrating exemplary embodiments. For example, an eNB 1404 located in an MBSFN cell 1402 may send an eMBMS service to a UE 1406 in one or more MBSFN subframes 1408, 1410, 1412. For example, each MBSFN subframe 1408, 1410, 1412 can carry one or more RLC PDUs (not illustrated in FIG. 14A), and each RLC PDU can carry one or more IP packets. Each IP packet can carry one or more segments of video and/or audio data related to the eMBMS service. In one aspect, one IP packet can be segmented into more than one MBSFN subframe. For example, a first MBSFN subframe 1408 transmitted to but not received by the UE 1406 can contain entire IP packet 1 and a first segment of IP packet 2. However, a second MBSFN subframe 1410 containing the second segment of IP packet 2 may be received by the UE 1406. A third MBSFN subframe 1412 containing a third segment of the IP packet 2 and entire IP packet 3 can also be received by the UE 1406. Alternatively, entire IP packet 2 can be carried in a single MBSFN subframe where an end segment of IP packet 2 is received by the UE but the beginning segment and the UDP/IP packet 2 header is not received by the UE 1406.

In an exemplary embodiment, when the first segment of IP packet 2 is not received, the UE 1406 can assemble a replacement IP packet 1416 using the second segment of IP packet 2 received in the second MBSFN subframe 1410 and IP packet 3 received in the third MBSFN subframe 1412. In assembling the replacement IP packet 1416, the RLC layer can first discard partially received symbols and include received whole symbols of the payload in the replacement IP packet 1416. In an exemplary embodiment, the discarded partially received symbols can be FLUTE FEC symbols. For example, a partially received IP packet may contain data bytes of 10 whole symbols and data bytes of a partially received 11^{th} symbol. The data bytes of the partially received 11^{th} symbol can be discarded. In an aspect, the RLC layer can discard partially received FEC symbols prior to reassembling the IP packet or can insert the partially received IP packet with dummy data and let the upper layers discard partially received FEC symbols during the decoding process.

In an exemplary embodiment, with reference to FIG. 14B, the UE 1406 can generate a new FLUTE packet header using the symbol ID included in the second segment of IP packet 2 received in the second MBSFN subframe 1410 and the FLUTE packet 3 header included in the IP packet 3 received in the third MBSFN subframe 1412. The new FLUTE packet header can include an updated encoding symbol ID (ESI) that matches the symbol ID included in the second segment of IP packet 2. For example, the encoding symbol ID (ESI) of the next received FLUTE packet header can be updated to create a new FLUTE packet header for the replacement IP packet 1416. If, for example, the number of full symbols of the successfully received second segment of IP Packet is N, and the ESI of the next received FLUTE packet is M, then the ESI of the new FLUTE packet header is M-N. The UE 1406 can assemble the replacement IP packet 1416 to include UDP/IP Packet 3 Header included with IP packet 3 received in the third MBSFN subframe 1412, the new FLUTE packet header which can be inserted directly after the UDP IP Packet 3 Header, the second segment of IP packet 2 received in the second MBSFN subframe 1410 inserted after the FLUTE packet header, and IP packet 3 is inserted after the second segment of IP packet 2. In assembling the replacement IP packet 1416, the payload of the second segment of IP packet 2 and/or IP packet 3 may have to be modified by the UE 1406. The modification may affect a UDP checksum which applies to the UDP/IP 3 Header, the second segment of IP packet 2, and/or IP packet 3. In one aspect, the RLC layer may need to recalculate the checksum, modify the checksum to zero, or the RLC layer may not verify the UDP checksum. The RLC layer may know which FEC symbols are correctly received and delete partially received symbols prior to filling the missing bytes of the IP packet with dummy data since the eMBMS service layer can provide to the RLC layer the symbol size and FLUTE packet header size.

Therefore, in the case that an IP packet is transmitted across more than one MBSFN subframe and the UE 1406 does not receive one of the MBSFN subframes, e.g., due to an air interface transmission error or if the UE 1406 is a dual subscriber identity modules (SIMs) device that tunes away to other radio access technology from LTE, then the present disclosure provides a mechanism by which that the RLC layer can reassemble a partially received IP packet rather than drop the partially received IP packet (e.g., IP packet 2) to allow recovery of additional data (e.g., FEC symbols) that was received in a segment of the IP packet (e.g., IP packet 2). Use of the FEC symbols received in the partial IP packet may result in better video streaming and/or file download eMBMS services to the user.

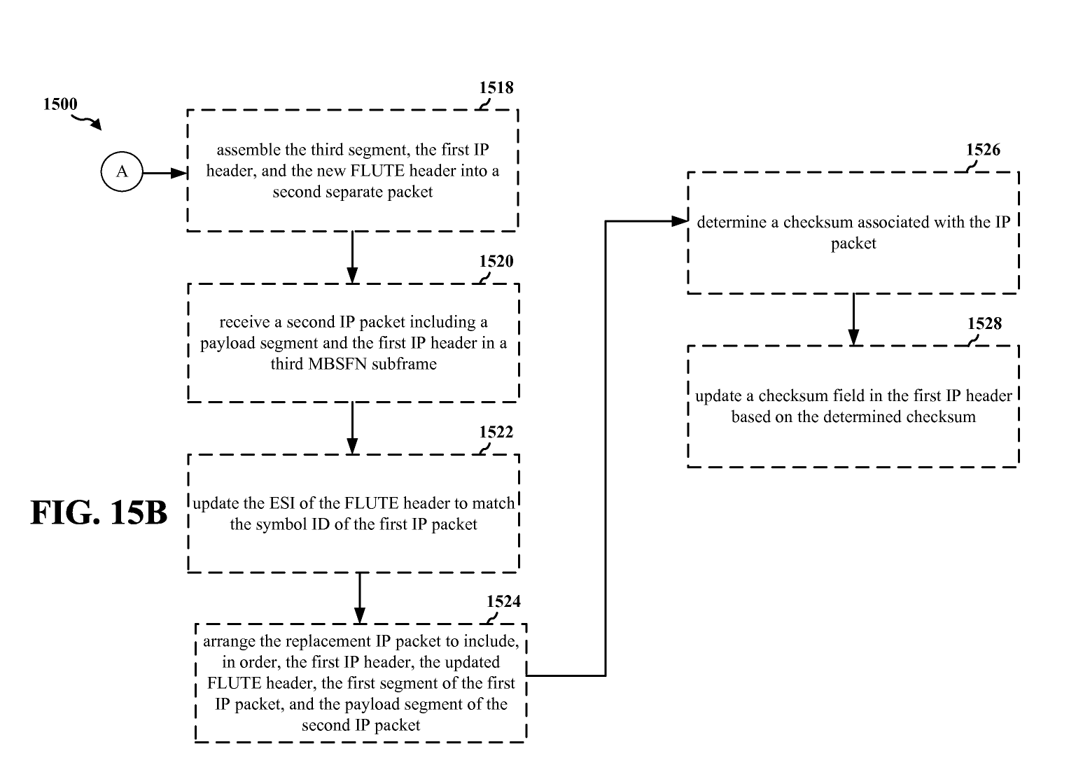

FIGS. 15A-15B are a flow chart 1500 of a method of wireless communication. The method may be performed by a UE, such as UE 906, 1206, 1306, and/or 1406. The operations indicated with dashed lines represent optional operations that may be performed by various aspects of the disclosure.

In block 1502, a UE can receive a first segment of a first internet protocol (IP) packet in a first multicast broadcast single frequency network (MBSFN) subframe. In an aspect, the first segment can include a beginning segment, a middle segment, or an end segment of the first IP packet. For example, referring to FIG. 12A, the UE 1206 can receive a first segment that is the beginning segment of IP Packet 2 in a first MBSFN subframe 1208. Alternatively, referring to FIG. 14A, the UE 1406 can receive a first segment that is the end segment of IP Packet 2 in a second MBSFN subframe 1410.

In an aspect, the first MBSFN subframe can include a first IP header comprising information associated with the first IP packet. In another aspect, the first segment of the first IP packet includes a file delivery over unidirectional transport (FLUTE). In an exemplary embodiment, the first IP header can include information associated with a second IP packet. For example, referring to FIGS. 12A and 12B, the first MBSFN subframe 1208 can include a UDP/IP Packet 2 header and/or a FLUTE header.

In one aspect, when the first segment is an end segment of the first IP packet and the second segment is a beginning segment of the first IP packet, the UE can receive a second IP packet including a payload segment and the first IP header in a third MBSFN subframe. For example, referring to FIG. 14A, the UE 1406 can receive a second IP packet (e.g., IP Packet 3) in the third MBSFN subframe 1412. In another aspect, the payload segment can include a file delivery over unidirectional transport (FLUTE) header comprising an encoding symbol ID (ESI). For example, referring to FIG. 14B, the third MBSFN subframe 1412 includes a payload segment (e.g., IP Packet 3) that includes a FLUTE packet header with an ESI=M. In an aspect, the first segment of the first IP packet can include a symbol identification (ID). For example, referring to FIG. 14B, the UE 1406 can receive the first segment of the IP packet that is the end segment of IP Packet 2 which includes a number of symbols=N.

In one aspect, the UE can receive a third segment of the first IP packet in a third MBSFN subframe. For example, referring to FIGS. 13A-13C, the UE 1306 can receive a third segment of IP Packet 2 in the third MBSFN subframe 1312. In an exemplary embodiment, the first MBSFN subframe, the second MBSFN subframe, and the third MBSFN subframe are in order. In an exemplary embodiment, the first MBSFN subframe, the second MBSFN subframe, and the third MBSFN subframe are not in order. In an exemplary embodiment, one or more of the first MBSFN subframe, the second MBSFN subframe, and the third MBSFN subframe are the same subframe.

In block 1504, the UE can determine a second segment of the first IP packet is not received in a second MBSFN subframe. For example, referring to FIGS. 12A and 12B, the UE 1206 can determine that the second segment of IP Packet 2 is not received in the second MBSFN subframe 1210. In an exemplary embodiment, the second segment of the first IP packet can include a beginning segment (e.g., see FIGS. 14A and 14B), a middle segment (e.g., see FIGS. 13A and 13B), or an end segment (e.g., see FIGS. 12A and 12B) of the first IP packet (e.g., IP Packet 2).

In an aspect, the RLC sequence number (SN) can be used to determine how the IP packet was lost. For example, referring to FIG. 12A, there may be two MBSFN subframes corresponding to the RLC Packets with SN=n, n+1, assuming one RLC PDU per MBSFN subframe. However, in this example, the UE receives only SN=n but does not receive SN=n+1 (and UE can receive another SN=n+2). Because SN=n+1 was not received, the UE knows that there is missing data and can apply the partially received IP packet procedure. In SN=n, FI=01, UE can determine that the initial part of the second IP packet has been received, and if SN=n+1 is not received, the UE can determine that the ending or middle part of the second IP packet has not been received. To confirm that SN=n+1 is the end segment of the IP packet and not the middle part, the UE can use Total length of the IP packet to make this determination. For example, assume that in SN=n, 100 bytes has been received by the UE for the second IP packet, and that IP header has Total length=1400 bytes. Therefore, if SN=n+1 is supposed to send 1500 bytes (e.g., which may be determined from the MCS of the second MBSFN subframe and/or the MBSFN transmission if the MCS is the same in each subframe), then the UE can detect that SN=n+1 is the end segment and not the middle part. On the other hand, if SN=n+1 is supposed to send 1200 bytes (e.g., which may be determined from the MCS of the second MBSFN subframe and/or the MBSFN transmission if the MCS is the same in each subframe), then the UE can detect that SN=n+1 has the middle part. Alternatively, IP packet size is typically constant and the UE can detect this constant value by receiving a few IP packets. As such, the RLC layer can predict which part is missing without needing the Total length when leading portion of the IP packet is missing.

In block 1506, the UE can assemble a replacement IP packet that includes the first segment of the first IP packet and a first IP header, and does not include the second segment of the first IP packet. For example, referring to FIGS. 12A and 12B, the UE 1206 can assemble 1212 a replacement IP packet that includes the first segment of IP packet 2 received in the first MBSFN subframe 1208 and dummy data used in place of the second segment of IP packet 2 that is not received in the second MBSFN subframe 1210.

In block 1508, the UE can perform forward error correction (FEC) on the assembled IP packet. In one aspect, the UE can recover additional data, e.g., FEC symbols, in the replacement IP packet. For example, referring to FIGS. 12A and 12B, when the UE 1206 determines that the first segment of IP packet 2 is received but not the second segment of IP packet 2, the UE (e.g., RLC layer) can reassemble IP packet 2 by filling out the missing second segment of IP packet 2 with dummy bytes of data. The RLC layer can then forward the replacement IP packet 2 to the FLUTE layer to recover FEC symbols contained in the replacement IP packet 2. In an exemplary embodiment, the RLC layer can indicate to the FLUTE layer which segment of replacement IP packet 2 1212 was received (e.g., the first segment of IP packet 2) and which part has dummy data (e.g., the second segment of IP packet 2). The FLUTE layer can discard the dummy data inserted in place of the second segment of IP packet 2. Referring to FIG. 12B, multiple FEC symbols may be included in the first segment of IP packet 2 following the UDP/IP Packet 2 header, each FEC symbol of S bytes, excluding the FLUTE packet header which follows the UDP/IP Packet 2 header. In one aspect, the FLUTE layer can use S*FLOOR(L/S) bytes of data to process and discard the remaining bytes of partial FEC symbols not useable by the FLUTE layer, where L is the length of the successfully received data in the first segment of IP packet 2, excluding the FLUTE packet header which, for example, may include 16 bytes. FLOOR is a function to take the lower integer of the non-integer number of bytes of data. For example, FLOOR(1350/100)=FLOOR(13.5)=13 bytes that can be used to process and discard the remaining bytes of partial PEC symbols not usable by the FLUTE layer. Alternatively, the RLC layer can discard partially received FEC symbols prior to reassembling the IP packet or can insert the partially received IP packet with dummy data and let the upper layers discard partially received FEC symbols during the decoding process.

In block 1510, the UE can determine a length of the second segment of the first IP packet based on a length of the first segment of the first IP packet and the information associated with the first IP packet included in the first IP header. For example, referring to FIG. 13B, to determine the amount of dummy data to insert in the missing section segment of IP packet 2, the UE 1306 can refer to the Total Length field in the UDP/IP Packet 2 Header to determine the size of entire IP packet 2 and the RLC SDU size of the each data segment in the first and third segments of IP packet 2 received. The difference between the total size of the entire IP packet 2 and each of the received segments of IP packet 2 is the amount of dummy data inserted into the replacement IP packet 2 1314.

In block 1512, the UE can receive a third segment of the first IP packet in a third MBSFN subframe. For example, referring to FIG. 13A, the UE 1306 can receive a third segment of IP Packet 2 in the third MBSFN subframe 1312.

In block 1514, the UE can generate a new FLUTE header based on an encoding symbol identification (ESI) associated with the third segment. For example, referring to FIGS. 13A and 13C, the UE 1306 can generate a new FLUTE packet header in a second new packet 1318 using the symbol ID=N+K in the third segment of IP Packet 2 received in the third MBSFN subframe 1312.

In block 1516, the UE can assemble the first segment and the first IP header into a first separate packet. For example, referring to FIGS. 13A and 13C, the UE 1306 can assemble 1314 a first new packet 1316 using the first segment of IP Packet 2 and the UDP/IP Packet 2 Header and FLUTE packet header received in the first MBSFN subframe 1308.

As shown in FIG. 15B, in block 1518, the UE can assemble the third segment, the first IP header, and the new FLUTE header into a second separate packet. For example, referring to FIGS. 13A and 13C, the UE 1306 can generate a new FLUTE packet header based on the symbol ID included in the third segment of IP packet 2 and assemble the new FLUTE packet header, the UDP/IP Packet 2 Header received in the first MBSFN subframe 1308 with the third segment of IP packet 2 into a second new packet 1318.

In block 1520, the UE can receive a second IP packet including a payload segment and the first IP header in a third MBSFN subframe. For example, referring to FIGS. 14A and 14B, IP Packet 3 (e.g., a second IP packet) that includes a payload segment and UDP/IP Packet 3 Header (e.g., the first IP header) in the third MBSFN subframe 1412.

In block 1522, the UE can update the ESI of the FLUTE header to match the symbol ID of the first IP packet. For example, referring to FIG. 14B, the UE 1406 can generate a new FLUTE packet header using the symbol ID included in the second segment of IP packet 2 received in the second MBSFN subframe 1410 and the FLUTE packet 3 header included in the IP packet 3 received in the third MBSFN subframe 1412. The new FLUTE packet header can include an updated encoding symbol ID (ESI) that matches the symbol ID included in the second segment of IP packet 2. For example, the encoding symbol ID (ESI) of the next received FLUTE packet header can be updated to create a new FLUTE packet header for the replacement IP packet 1414. If, for example, the number of full symbols of the successfully received second segment of IP Packet is N, and the ESI of the next received FLUTE packet is M, then the ESI of the new FLUTE packet header is M-N.

In block 1524, the UE can arrange the IP packet to include, in order, the first IP header, the updated FLUTE header, the first segment of the first IP packet, and the payload segment of the second IP packet. For example, referring to FIG. 14B, the UE 1406 can assemble the replacement IP packet 1416 to include UDP/IP Packet 3 Header included with IP packet 3 received in the third MBSFN subframe 1412, the new FLUTE packet header which is inserted directly after the UDP IP Packet 3 Header, the second segment of IP packet 2 received in the second MBSFN subframe 1410 inserted after the FLUTE packet header, and IP packet 3 is inserted after the second segment of IP packet 2.

In block 1526, the UE can determine a checksum associated with the IP packet. For example, referring to FIG. 12B, the UE 1206 can determine a checksum of IP packet 2 using information included the UDP checksum portion of the UDP/IP Packet 2 Header received in the first MBSFN subframe 1208.

In block 1528, the UE can update a checksum field in the first IP header based on the determined checksum. For example, referring to FIG. 14B, in assembling the replacement IP packet 1416, the payload of the second segment of IP packet 2 and/or IP packet 3 may have to be modified by the UE 1406. This may affect a UDP checksum which applies to the UDP/IP 3 Header, the second segment of IP packet 2, and/or IP packet 3. In one aspect, the RLC may need to recalculate the checksum, modify the checksum to a zero value, or the RLC may not verify the UDP checksum (e.g., leave the checksum unmodified).

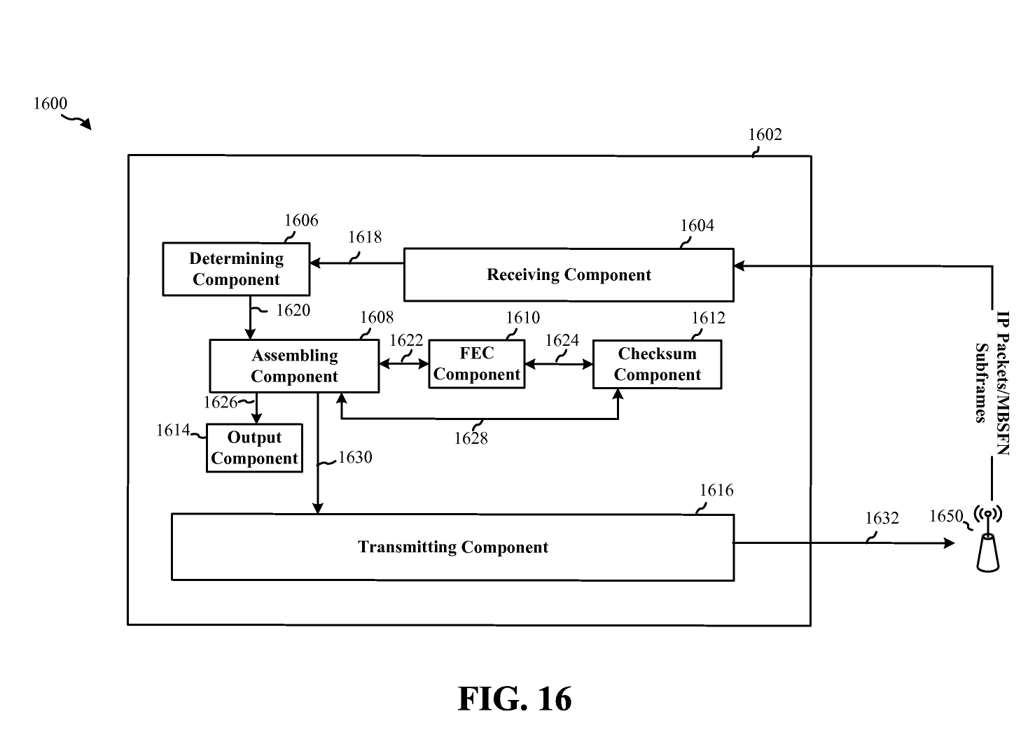

FIG. 16 is a conceptual data flow diagram 1600 illustrating the data flow between different modules/means/components in an exemplary apparatus 1602. The apparatus may include a UE, such as UEs 906, 1206, 1306, or 1406 in FIGS. 9, 12A, 13A, or 14A. The apparatus includes a component 1604 that receives, from the base station 1650, an eMBMS service in one or more MBSFN subframes. For example, each MBSFN subframe received at component 1604 can carry one or more RLC protocol data units (PDU), and each RLC PDU can contain one or more IP packets. Each IP packet can carry one or more segments of video and/or audio data related to the eMBMS service. In one aspect, one IP packet can be segmented into one or more RLC PDUs. For example, component 1604 can receive a first segment of an IP packet in a first MBSFN subframe, not receive a second segment of the IP packet in a second MBSFN subframe, and receive a third segment of the IP packet in a third MBSFN subframe. Alternatively, for example, component 1604 may not receive the first segment of the IP packet in a first MBSFN subframe, receive the second segment of the IP packet in a second MBSFN subframe, and receive a second IP packet in a third MBSFN subframe. Component 1604 sends a signal 1618 related to the IP packets to component 1606. Component 1606 can determine if one or more segments of an IP packet are not received in one or more MBSFN subframes. If component 1606 determines that a second segment of an IP packet is not received in a second MBSFN subframe, component 1606 may send a signal 1620 to component 1608 indicating that the second segment of the IP packet was not received. Component 1608 can assemble an IP packet that includes the first segment of the first IP packet and a first IP header, and does not include the second segment of the first IP packet. If the IP packet is segmented into three segments and the third segment of the IP packet is received, component 1608 can include the third segment of the IP packet in the assembled packet. For example, component 1608 assembles the IP packet by replacing the unreceived second segment of the first IP packet with dummy data. Component 1608 can determine a length of the second segment of the first IP packet based on a length of the first segment of the first IP packet and the information associated with the first IP packet included in the first IP header. For example, the amount of dummy data that component 1608 includes in the assembled IP packet is based on the determined length of the second segment.

Alternatively, component 1608 can assemble a first new packet using the first segment of the IP packet and the UDP/IP packet header and the FLUTE packet header received in the first MBSFN subframe and the FLUTE packet header, and a second new packet including the third segment of the IP packet, the UDP/IP packet header received in the first MBSFN subframe, and a new FLUTE packet header that includes an updated encoding symbol ID that corresponds to the symbol ID received in the third segment of the IP packet. If component 1604 does not receive the first segment of the IP packet in a first MBSFN subframe, but receives the second segment of the IP packet in a second MBSFN subframe and a second IP packet in a third MBSFN subframe, component 1608 can assemble a replacement IP packet that includes a UDP/IP Packet Header received in the third MBSFN subframe, a new FLUTE packet header that includes an updated ESI that corresponds to the second segment of the first IP packet and the second IP packet, the second segment of the first IP packet, and the second IP packet. Component 1608 may send a signal 1622 to component 1610 related to the assembled IP packet. For example, the signal 1622 can be related to which segment of the IP packet is missing. Component 1610 can perform forward error correction (FEC) on the assembled IP packet to recover data symbols. Component 1610 may send a signal 1622 to component 1608 related to the FEC. Component 1608 can update the assembled IP packet based on the signal 1622 received from component 1610 related to the FEC and the recovered data symbols. Component 1608 can also send a signal 1628 to component 1612 related to the assembled IP packet. For example, signal 1628 can include information related to the assembled IP packet and the FEC. Alternatively, component 1610 may send a signal 1624 to component 1612 that includes information related to the assembled IP packet, the FEC, and the recovered data symbols. Component 1612 can determine a checksum of IP packet using information included the UDP checksum portion of the UDP/IP Packet Header received in an MBSFN subframe. Component 1612 can update a checksum field in the assembled IP header based on the determined checksum, and send a signal 1628 back to component 1608 related to the updated checksum field in the IP header of the assembled IP packet. Component 1608 may send a signal 1626 to component 1614 associated with the assembled IP packet. Component 1614 can output information associated with the assembled IP packet. For example, the information output can be related to an eMBMS service and include video and/or audio. Component 1608 can also send a signal 1630 to transmitting component 1616 related to the assembled IP packet and/or FEC. Component 1616 can transmit information 1632 to base station 1650 related to the assembled IP packet.

The apparatus may include additional components that perform each of the blocks of the algorithm in the aforementioned flow chart of FIGS. 15A-15B. As such, each block in the aforementioned flow chart of FIGS. 15A-15B may be performed by a component and the apparatus may include one or more of components 1604, 1606, 1608, 1610, 1612, 1614, 1616. The components may be one or more hardware components specifically configured to carry out the stated processes/algorithm, implemented by a processor configured to perform the stated processes/algorithm, stored within a computer-readable medium for implementation by a processor, or some combination thereof.

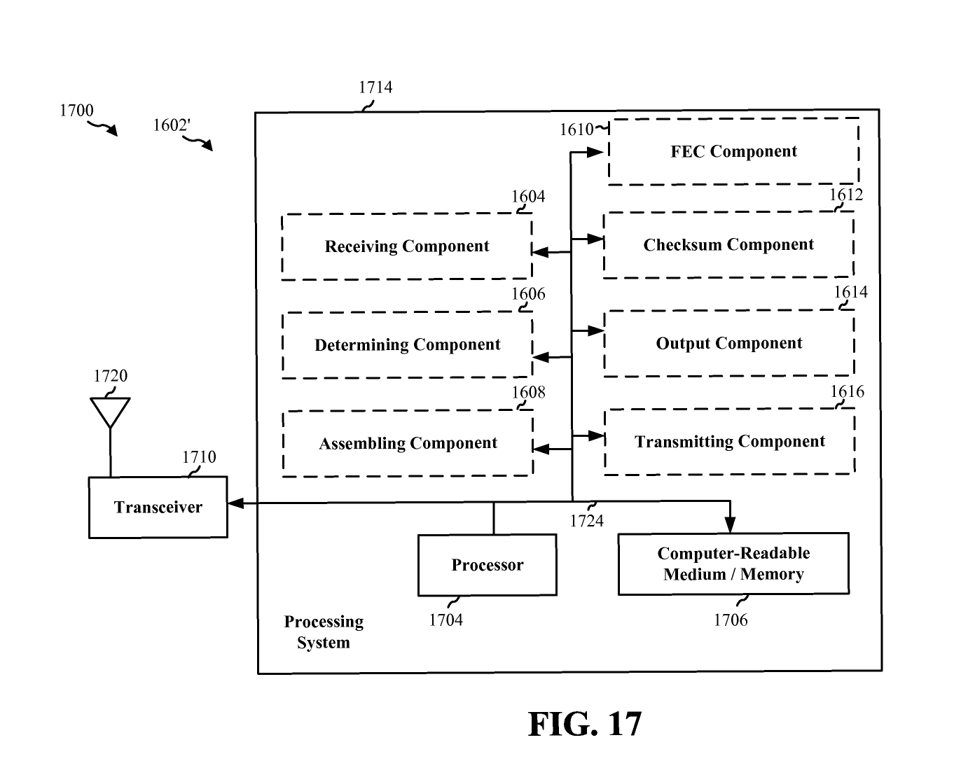

FIG. 17 is a diagram 1700 illustrating an example of a hardware implementation for an apparatus 1602′ employing a processing system 1714. The processing system 1714 may be implemented with a bus architecture, represented generally by the bus 1724. The bus 1724 may include any number of interconnecting buses and bridges depending on the specific application of the processing system 1714 and the overall design constraints. The bus 1724 links together various circuits including one or more processors and/or hardware components, represented by the processor 1704, the components 1604, 1606, 1608, 1610, 1612, 1614, and 1616 and the computer-readable medium/memory 1706. The bus 1724 may also link various other circuits such as timing sources, peripherals, voltage regulators, and power management circuits, which are well known in the art, and therefore, will not be described any further.

The processing system 1714 may be coupled to a transceiver 1710. The transceiver 1710 is coupled to one or more antennas 1720. The transceiver 1710 provides a means for communicating with various other apparatus over a transmission medium. The transceiver 1710 receives a signal from the one or more antennas 1720, extracts information from the received signal, and provides the extracted information to the processing system 1714, specifically the receiving component 1604. In addition, the transceiver 1710 receives information from the processing system 1714, specifically the transmitting component 1616, and based on the received information, generates a signal to be applied to the one or more antennas 1720. The processing system 1714 includes a processor 1704 coupled to a computer-readable medium/memory 1706. The processor 1704 is responsible for general processing, including the execution of software stored on the computer-readable medium/memory 1706. The software, when executed by the processor 1704, causes the processing system 1714 to perform the various functions described supra for any particular apparatus. The computer-readable medium/memory 1706 may also be used for storing data that is manipulated by the processor 1704 when executing software. The processing system further includes at least one of the components 1604, 1606, 1608, 1610, 1612, 1614, and 1616. The components may be software components running in the processor 1704, resident/stored in the computer readable medium/memory 1706, one or more hardware components coupled to the processor 1704, or some combination thereof. The processing system 1714 may be a component of the UE 650 and may include the memory 660 and/or at least one of the TX processor 668, the RX processor 656, and the controller/processor 659.

In one configuration, the apparatus 1602/1602′ for wireless communication includes means for receiving a first segment of a first IP packet in a first MBSFN subframe. In addition, the apparatus 1602/1602′ for wireless communication includes means for determining a second segment of the first IP packet is not received in a second MBSFN subframe. Furthermore, the apparatus 1602/1602′ for wireless communication includes means for assembling a replacement IP packet that includes the first segment of the first IP packet and a first IP header. The means for assembling the replacement IP packet is configured to replace the unreceived second segment of the first IP packet with dummy data. Still further, the apparatus 1602/1602′ for wireless communication includes means for performing FEC on the replacement IP packet, wherein the means for performing the FEC on the replacement IP packet is configured to recover additional data associated with the second segment of the first IP packet from FEC data in the first segment. Additionally, the apparatus 1602/1602′ for wireless communication includes means for determining a length of the second segment of the first IP packet based on a length of the first segment of the first IP packet and the information associated with the first IP packet included in the first IP header, wherein an amount of dummy data that is included in the replacement IP packet is based on the determined length of the second segment. In further addition, the apparatus 1602/1602′ for wireless communication includes means for receiving a third segment of the first IP packet in a third MBSFN subframe, wherein the replacement IP packet further includes the third segment of the first IP packet, wherein the first segment of the first IP packet includes a FLUTE header and the first MBSFN subframe includes the first IP header associated with the first IP packet. Moreover, the means for assembling the replacement IP packet is configured to generate a new FLUTE header based on an ESI associated with the third segment to assemble the first segment and the first IP header into a first separate packet, and/or to assemble the third segment, the first IP header, and the new FLUTE header into a second separate packet. For example, the first segment can be an end segment of the first IP packet and the second segment is a beginning segment of the first IP packet. Furthermore, the apparatus 1602/1602′ for wireless communication includes means for receiving a second IP packet including a payload segment and the first IP header in a third MBSFN subframe, wherein the first segment of the first IP packet comprises a symbol ID, wherein the first IP header includes information associated with the second IP packet, and/or wherein the payload segment includes a FLUTE header comprising an encoding symbol ID ESI. In an aspect, the means for assembling the replacement IP packet is configured to update the ESI of the FLUTE header to match the symbol ID of the first IP packet, and to arrange the replacement IP packet to include, in order, the first IP header, the updated FLUTE header, the first segment of the first IP packet, and the payload segment of the second IP packet. Still further, the apparatus 1602/1602′ for wireless communication includes means for determining a checksum associated with the IP packet. Furthermore, the apparatus 1602/1602′ for wireless communication includes means for updating a checksum field in the first IP header based on the determined checksum. For example, the first MBSFN subframe includes the first IP header comprising information associated with the first IP packet, the second segment of the first IP packet is a beginning segment, a middle segment, or an end segment of the first IP packet, and/or the second segment is the middle segment of the first IP packet. The aforementioned means may be one or more of the aforementioned components of the apparatus 1602 and/or the processing system 1714 of the apparatus 1602′ configured to perform the functions recited by the aforementioned means. As described supra, the processing system 1714 may include the TX Processor 668, the RX Processor 656, and the controller/processor 659. As such, in one configuration, the aforementioned means may be the TX Processor 668, the Processor 656, and the controller/processor 659 configured to perform the functions recited by the aforementioned means.

The specific order or hierarchy of blocks in the processes/flow charts disclosed is an illustration of exemplary approaches. Based upon design preferences, the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication implemented by a user equipment (UE), comprising:
receiving a first segment of a first internet protocol (IP) packet in a first multicast broadcast single frequency network (MBSFN) subframe;
determining a second segment of the first IP packet is not received in a second MBSFN subframe;
assembling a replacement IP packet that includes the first segment of the first IP packet and a first IP header; and
performing forward error correction (FEC) on the replacement IP packet.

2. The method of claim 1, wherein the assembling the replacement IP packet comprises replacing the unreceived second segment of the first IP packet with dummy data.

3. The method of claim 2, wherein the first MBSFN subframe includes the first IP header, the first IP header comprising information associated with the first IP packet.

4. The method of claim 3, further comprising:
determining a length of the second segment of the first IP packet based on a length of the first segment of the first IP packet and the information associated with the first IP packet included in the first IP header;
wherein an amount of dummy data that is included in the replacement IP packet is based on the determined length of the second segment.

5. The method of claim 2, wherein the performing the FEC on the replacement IP packet comprises recovering at least one FEC symbol in the first segment.

6. The method of claim 2, further comprising:
receiving a third segment of the first IP packet in a third MBSFN subframe;
wherein the replacement IP packet further includes the third segment of the first IP packet.

7. The method of claim 6, wherein the second segment of the first IP packet is a beginning segment, a middle segment, or an end segment of the first IP packet.

8. The method of claim 7, wherein the first segment of the first IP packet includes a file delivery over unidirectional transport (FLUTE) header and the first MBSFN subframe includes the first IP header associated with the first IP packet, and wherein the assembling the IP replacement packet comprises:
generating a new FLUTE header based on an encoding symbol identification (ESI) associated with the third segment;
assembling the first segment and the first IP header into a first separate packet; and
assembling the third segment, the first IP header, and the new FLUTE header into a second separate packet.

9. The method of claim 8, wherein the second segment is the middle segment of the first IP packet.

10. The method of claim 1, wherein the first segment is an end segment of the first IP packet and the second segment is a beginning segment of the first IP packet, the method further comprising:
receiving a second IP packet including a payload segment and the first IP header in a third MBSFN subframe.

11. The method of claim 10, wherein:
the first segment of the first IP packet comprises a symbol identification (ID);
the first IP header includes information associated with the second IP packet; and
the payload segment includes a file delivery over unidirectional transport (FLUTE) header comprising an encoding symbol ID (ESI).

12. The method of claim 11, wherein the assembling the replacement IP packet comprises:
updating the ESI of the FLUTE header to match the symbol ID; and
arranging the replacement IP packet to include, in order, the first IP header, the FLUTE header with the updated ESI, the first segment of the first IP packet, and the payload segment of the second IP packet.

13. The method of claim 1, further comprising:
determining a checksum associated with the replacement IP packet; and
updating a checksum field in the first IP header based on the determined checksum.

14. An apparatus for wireless communication, comprising:
a memory; and
at least one processor coupled to the memory and configured to:
receive a first segment of a first internet protocol (IP) packet in a first multicast broadcast single frequency network (MBSFN) subframe;
determine a second segment of the first IP packet is not received in a second MBSFN subframe;
assemble a replacement IP packet that includes the first segment of the first IP packet and a first IP header; and
perform forward error correction (FEC) on the replacement IP packet.

15. The apparatus of claim 14, wherein the at least one processor is configured to assemble the replacement IP packet by replacing the unreceived second segment of the first IP packet with dummy data.

16. The apparatus of claim 15, wherein the first MBSFN subframe includes the first IP header, the first IP header comprising information associated with the first IP packet.

17. The apparatus of claim 16, wherein the at least one processor is further configured to:
determine a length of the second segment of the first IP packet based on a length of the first segment of the first IP packet and the information associated with the first IP packet included in the first IP header;
wherein an amount of dummy data that is included in the replacement IP packet is based on the determined length of the second segment.

18. The apparatus of claim 15, wherein the at least one processor is configured to perform the FEC on the replacement IP packet by recovering at least one FEC symbol in the first segment.

19. The apparatus of claim 15, wherein the at least one processor is further configured to:
receive a third segment of the first IP packet in a third MBSFN subframe;
wherein the replacement IP packet further includes the third segment of the first IP packet.

20. The apparatus of claim 19, wherein the second segment of the first IP packet is a beginning segment, a middle segment, or an end segment of the first IP packet.

21. The apparatus of claim 20, wherein the first segment of the first IP packet includes a file delivery over unidirectional transport (FLUTE) header and the first MBSFN subframe includes the first IP header associated with the first IP packet, and wherein the at least one processor is configured to assemble the IP replacement packet by:
generating a new FLUTE header based on an encoding symbol identification (ESI) associated with the third segment;
assembling the first segment and the first IP header into a first separate packet; and
assembling the third segment, the first IP header, and the new FLUTE header into a second separate packet.

22. The apparatus of claim 21, wherein the second segment is the middle segment of the first IP packet.

23. The apparatus of claim 14, wherein the first segment is an end segment of the first IP packet and the second segment is a beginning segment of the first IP packet, the at least one processor further configured to:
receive a second IP packet including a payload segment and the first IP header in a third MBSFN subframe.

24. The apparatus of claim 23, wherein:
the first segment of the first IP packet comprises a symbol identification (ID);
the first IP header includes information associated with the second IP packet; and
the payload segment includes a file delivery over unidirectional transport (FLUTE) header comprising an encoding symbol ID (ESI).

25. The apparatus of claim 24, wherein the at least one processor is configured to assemble the replacement IP packet by:
updating the ESI of the FLUTE header to match the symbol ID; and
arranging the replacement IP packet to include, in order, the first IP header, the FLUTE header with the updated ESI, the first segment of the first IP packet, and the payload segment of the second IP packet.

26. The apparatus of claim 14, wherein the at least one processor is configured to:
determine a checksum associated with the replacement IP packet; and
update a checksum field in the first IP header based on the determined checksum.

27. An apparatus for wireless communication, comprising:
means for receiving a first segment of a first internet protocol (IP) packet in a first multicast broadcast single frequency network (MBSFN) subframe;
means for determining a second segment of the first IP packet is not received in a second MBSFN subframe;
means for assembling an IP packet that includes the first segment of the first IP packet and a first IP header, and does not include the second segment of the first IP packet; and
means for performing forward error correction (FEC) on the replacement IP packet.

28. The apparatus of claim 27, wherein the means for assembling the IP packet is configured to replace the unreceived second segment of the first IP packet with dummy data.

29. A computer-readable medium storing computer executable code for wireless communication, comprising code for:
receiving a first segment of a first internet protocol (IP) packet in a first multicast broadcast single frequency network (MBSFN) subframe;
determining a second segment of the first IP packet is not received in a second MBSFN subframe;
assembling a replacement IP packet that includes the first segment of the first IP packet and a first IP header, and does not include the second segment of the first IP packet; and
performing forward error correction (FEC) on the replacement IP packet.

30. The computer-readable medium of claim 29, wherein the code for assembling the replacement IP packet further comprises code for replacing the unreceived second segment of the first IP packet with dummy data.
